(19) United States
(12) Patent Application Publication
(10) Pub. No.: US 2016/0192403 A1
(43) Pub. Date: Jun. 30, 2016

(54) MECHANISM TO PROVIDE LTE VOICE, INTERNET AND EMBMS SERVICES OVER ETHERNET FOR CONNECTED HOME ARCHITECTURE

(71) Applicant: QUALCOMM Incorporated, San Diego, CA (US)

(72) Inventors: Siddharth GUPTA, San Diego, CA (US); Rohit TRIPATHI, San Diego, CA (US); Kuo-Chun LEE, San Diego, CA (US); Sivaramakrishna VEEREPALLI, San Diego, CA (US); Tyler Byron WEAR, San Diego, CA (US); Vaibhav KUMAR, San Diego, CA (US)

(21) Appl. No.: 14/586,878

(22) Filed: Dec. 30, 2014

(51) Int. Cl. H04W 76/00; H04L 29/06; H04W 12/06; H04L 12/18

(52) U.S. Cl. CPC H04W 76/002; H04L 12/18; H04L 63/166; H04L 63/0876; H04W 12/06; H04W 84/12

(57) ABSTRACT

A method, an apparatus, and a computer program product for communication in a network. The apparatus sends a multicast message to a network device. The multicast message facilitates discovery of an unknown IP address of the network device. The apparatus determines whether a first response message is received from the network device in response to the multicast message and determines the IP address of the network device from the first response message when the first response message is received from the network device. The apparatus establishes a secure connection with the network device using the determined IP address. The apparatus sends a link status check message to the network device to detect a failed end-to-end link between the apparatus and the network device.

### BACKGROUND

1. Field

The present disclosure relates generally to communication systems, and more particularly, to a mechanism to provide Long Term Evolution (LTE) Voice, Internet and evolved Multimedia Broadcast Multicast Service (eMBMS) services over Ethernet for connected home architecture.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The method includes sending a multicast message to a network device, where the Internet Protocol (IP) address of the network device is unknown, determining whether a first response message is received from the network device in response to the multicast message, determining the IP address of the network device from the first response message when the first response message is received from the network device, and establishing a secure connection with the network device using the determined IP address.

The apparatus sends a multicast message to a network device. The multicast message facilitates discovery of the network device, where the IP address of the network device is unknown. The apparatus determines whether a first response message is received from the network device in response to the multicast message and determines the IP address of the network device from the first response message when the first response message is received from the network device. The apparatus establishes a secure connection with the network device using the determined IP address.

In an aspect of the disclosure, a method, a computer program product, and an apparatus are provided. For example, the method may be performed by a network device. The method includes monitoring a first port for a multicast message from a gateway, sending a first response message to the gateway when the multicast message is received, receiving a signal to initiate establishment of a secure connection on a second port, and establishing the secure connection with the gateway. The apparatus is configured to receive MBMS data, Internet traffic, and/or IMS traffic from a base station.

The apparatus monitors a first port for a multicast message from a gateway and sends a first response message to the gateway when the multicast message is received. The apparatus receives a signal to initiate establishment of a secure connection on a second port and establishes the secure connection with the gateway.

### BRIEF DESCRIPTION OF THE DRAWINGS

FIG. 1 is a diagram illustrating an example of a network architecture.

FIG. 2 is a diagram illustrating an example of an access network.

FIG. 3A is a diagram illustrating an example of an evolved Multimedia Broadcast Multicast Service channel configuration in a Multicast Broadcast Single Frequency Network.

FIG. 3B is a diagram illustrating a format of a Multicast Channel Scheduling Information Media Access Control control element.

FIG. 4 is a diagram illustrating an example network in accordance with various aspects of the disclosure.

FIG. 5 is a diagram illustrating a network architecture in accordance with various aspects of the disclosure.

FIG. 6 is a diagram illustrating data flow of the network architecture in accordance with various aspects of the disclosure.

FIG. 7 is a flow chart of a method for an ODU in accordance with various aspects of the disclosure.

FIG. 8 is a flow chart of a method for a gateway in accordance with various aspects of the disclosure.

FIG. 9 is a diagram illustrating a message flow between an ODU and gateway in accordance with various aspects of the disclosure.

FIG. 10 is a diagram illustrating a message flow between an ODU and gateway in accordance with various aspects of the disclosure.

FIG. 11 is a diagram illustrating a network architecture in accordance with various aspects of the disclosure.

FIGS. 12A and 12B are a flow chart of a method of communication.

FIGS. 13A and 13B are a flow chart of a method of communication.

FIG. 14 is a conceptual data flow diagram illustrating the data flow between different modules/means/components in an exemplary apparatus.

FIG. 15 is a conceptual data flow diagram illustrating the data flow between different modules/means/components in an exemplary apparatus.

FIG. 16 is a diagram illustrating an example of a hardware implementation for an apparatus employing a processing system.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to store desired program code in the form of instructions or data structures and that can be accessed by a computer. Combinations of the above should also be included within the scope of computer-readable media.

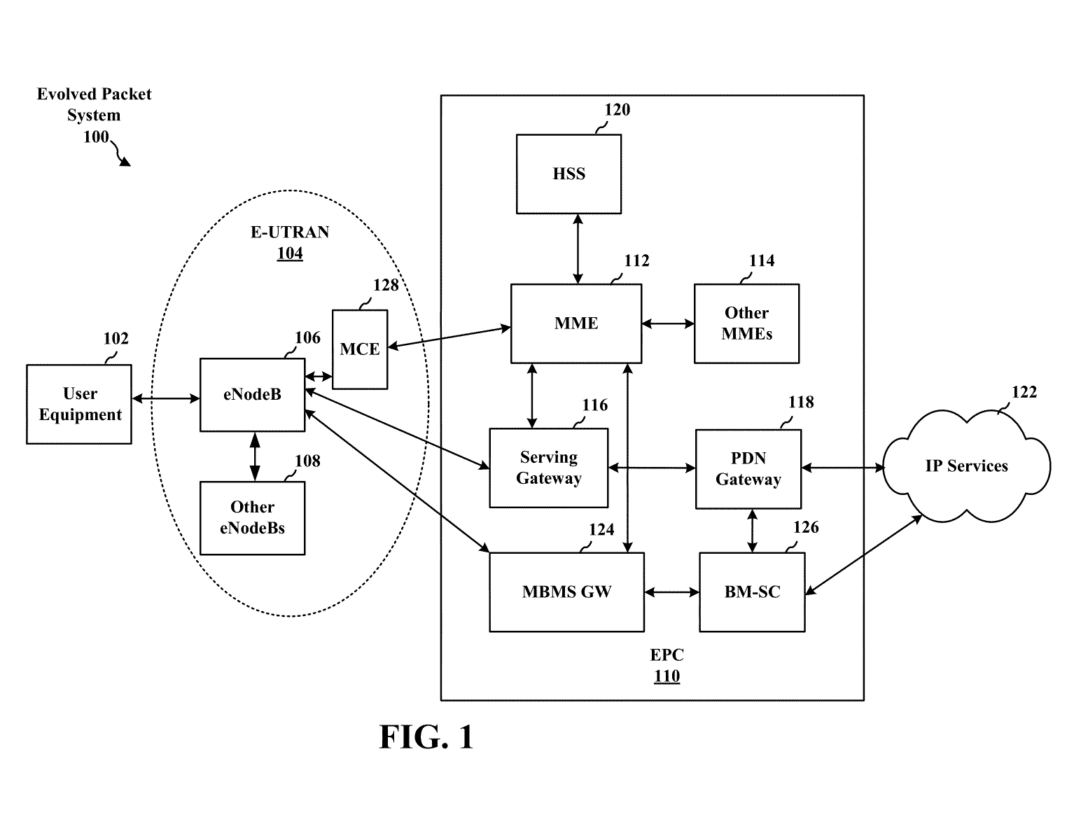

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. In the present disclosure, the term MBMS refers to both MBMS and eMBMS services. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

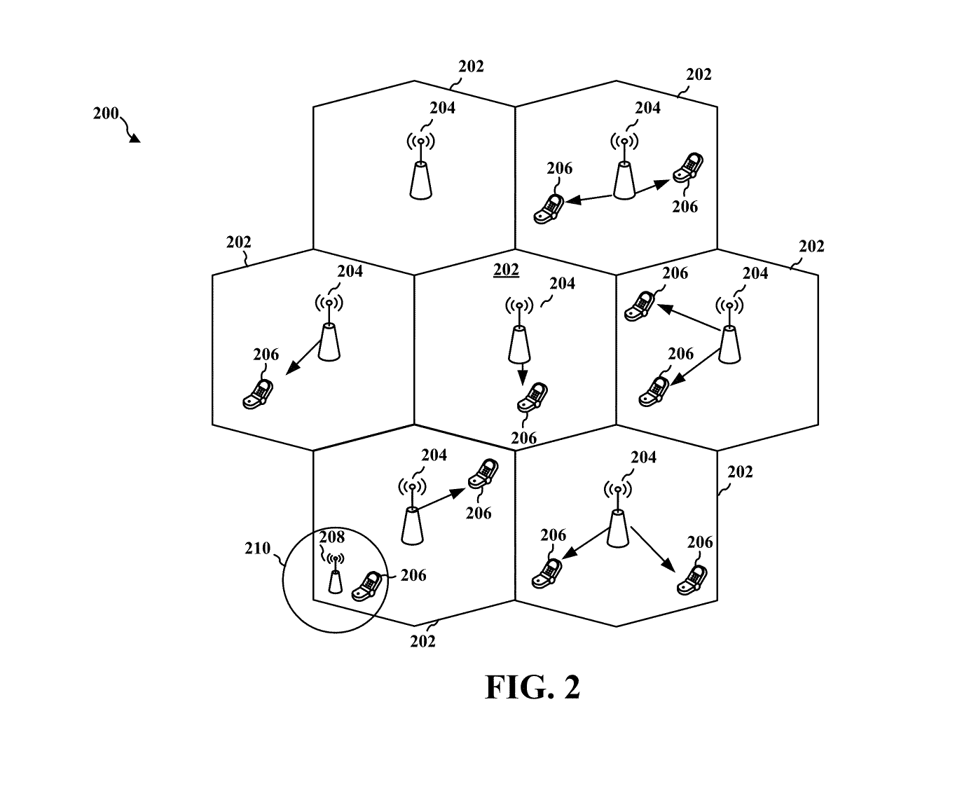

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

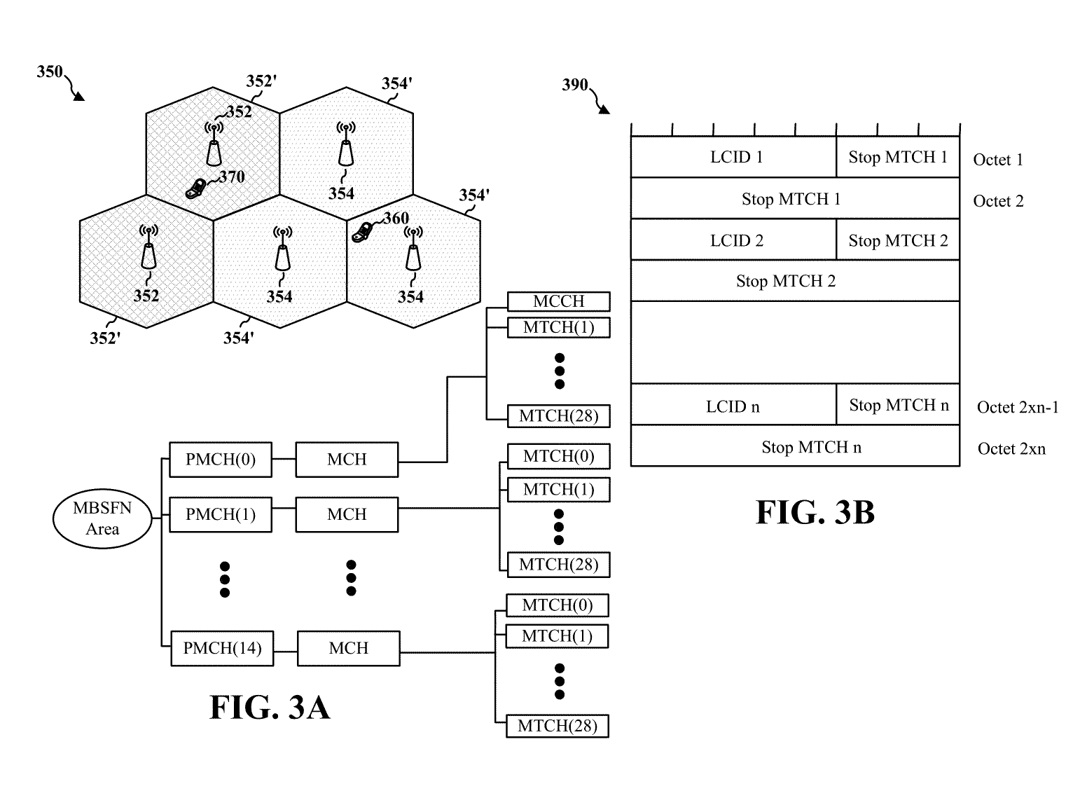

FIG. 3A is a diagram 350 illustrating an example of an evolved MBMS (eMBMS) channel configuration in an MBSFN. The eNBs 352 in cells 352′ may form a first MBSFN area and the eNBs 354 in cells 354′ may form a second MBSFN area. The eNBs 352, 354 may each be associated with other MBSFN areas, for example, up to a total of eight MBSFN areas. A cell within an MBSFN area may be designated a reserved cell. Reserved cells do not provide multicast/broadcast content, but are time-synchronized to the cells 352′, 354′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 3A, the first MBSFN area may support a first eMBMS broadcast service, such as by providing a particular news broadcast to UE 370. The second MBSFN area may support a second eMBMS broadcast service, such as by providing a different news broadcast to UE 360. Each MBSFN area supports one or more physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a system information block (SIB) 13 (SIB13). Subsequently, based on the SIB13, the UE may acquire an MBSFN Area Configuration message on an MCCH. Subsequently, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 3B is a diagram 390 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

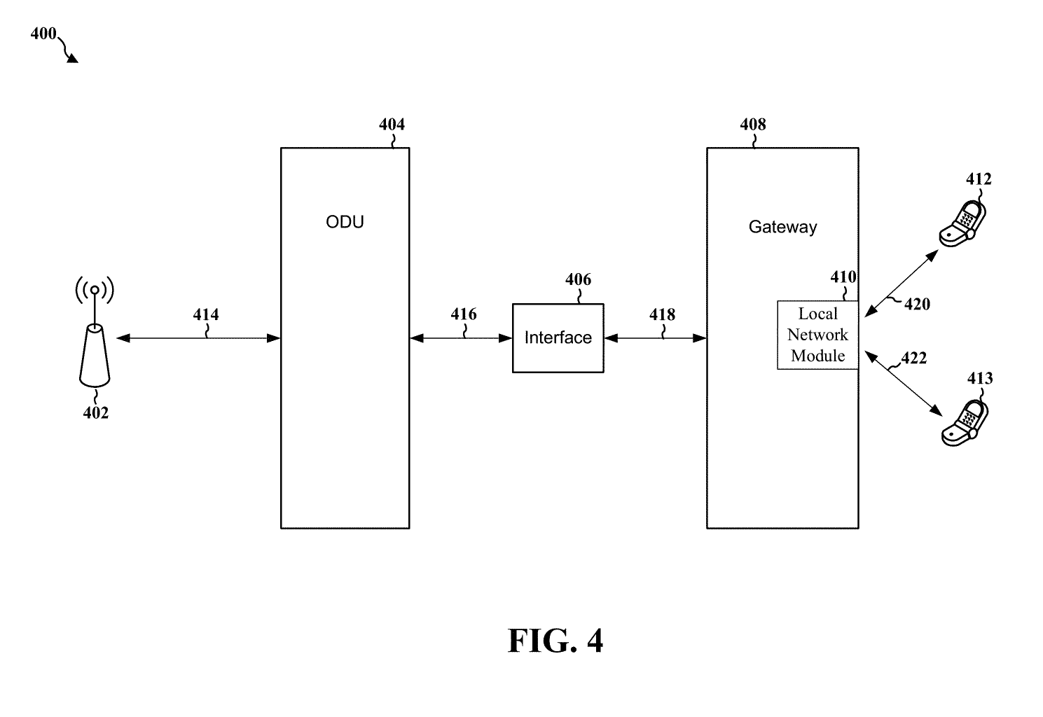

An out-door unit (ODU) and a gateway may be deployed to enable eMBMS, voice and Internet control and data plane functionality from a WWAN network to an end node/device connected to the gateway via a local area network, e.g. Ethernet or wireless local area network (WLAN). The ODU may establish a connection with the WWAN and deliver data to the gateway for delivery to the end node. In the present disclosure, the term ODU may refer to a device that may be installed outdoors, such as a dish antenna and associated components (e.g., receiver and transmitter). However, the term ODU may also refer to a device that may be installed indoors, such as an indoor antenna and associated components (e.g., receiver and transmitter). The ODU may be configured to operate in a bridge mode or a router mode. The ODU and gateway may discover the presence of each other, establish a secure connection, monitor the status of the secure connection, detect link failures, and recover from link failures. FIG. 4 is a diagram illustrating an example network 400 in accordance with various aspects of the disclosure. FIG. 4 includes a BS 402, out-door unit (ODU) 404, interface 406, gateway 408, and UEs 412, and 413. The ODU 404 may establish a communication link 414 with the BS 402 and may send and receive communications to and from the BS 402 over the communication link 414. For example, the communication link 414 may be established using a WAN radio access technology (RAT), such as LTE. In an aspect, the BS 402 may be configured to transmit and receive eMBMS traffic, IP Multimedia Subsystem (IMS) traffic, and/or Internet traffic over communication link 414 using WAN protocols. The BS 402 may be the eNodeB 106 of FIG. 1 or an eNB 204 of FIG. 2.

As shown in FIG. 4, the ODU 404 is coupled to the gateway 408 through the interface 406. In an aspect, the interface 406 may be configured to be internal to the ODU 404. For example, the interface 406 may be a USB to Ethernet interface. In such example, the ODU 404 may send and receive communications to and from the gateway 408 over data path 416 using USB protocols. The gateway 408 may send and receive communications to and from the ODU 404 over the data path 418 using Ethernet protocols. For example, data path 416 may be a USB cable and data path 418 may be an Ethernet cable. As shown in FIG. 4, the gateway 408 includes a local network module 410 configured to enable communications with one or more UEs, such as UEs 412, 413. In an aspect, the gateway 408 may be a home gateway. For example, the gateway 408 may be implemented as a wired and/or wireless router (e.g., a WiFi™ router). For example, the local network module 410 may be configured to communicate with the UEs 412, 413 using a WLAN protocol and/or a wired Ethernet protocol. Accordingly, in such example, the communication links 420, 422 may be a wireless WLAN communication link or a wired Ethernet communication link.

The UEs 412, 413 may be configured with one or more applications for processing various types of data traffic. For example, the UEs 412, 413 may include an eMBMS application for processing eMBMS data, an Internet application for processing Internet data, and/or an IMS application for processing IMS data. In an aspect, an eMBMS application operating in a UE (e.g., UE 412) in network 400 may send a query to the gateway 408 requesting an eMBMS service (e.g., content). The eMBMS service may be available in an eMBMS broadcast from the BS 402. For example, an eMBMS service module (also referred to as middleware) operating in the gateway 408 may forward the query to the ODU 404 over data path 418 using Ethernet protocols. The query may be received by the interface 406 and provided to the ODU 404 over data path 416 using USB protocols. The ODU 404 may then receive eMBMS data packets carrying the requested eMBMS service from the BS 402 using WAN protocols and may route the data packets to the gateway 408. The gateway 408 may then send the eMBMS data packets to the requesting UE (e.g., UE 412) via the local network module 410 using a WLAN protocol or a wired Ethernet protocol.

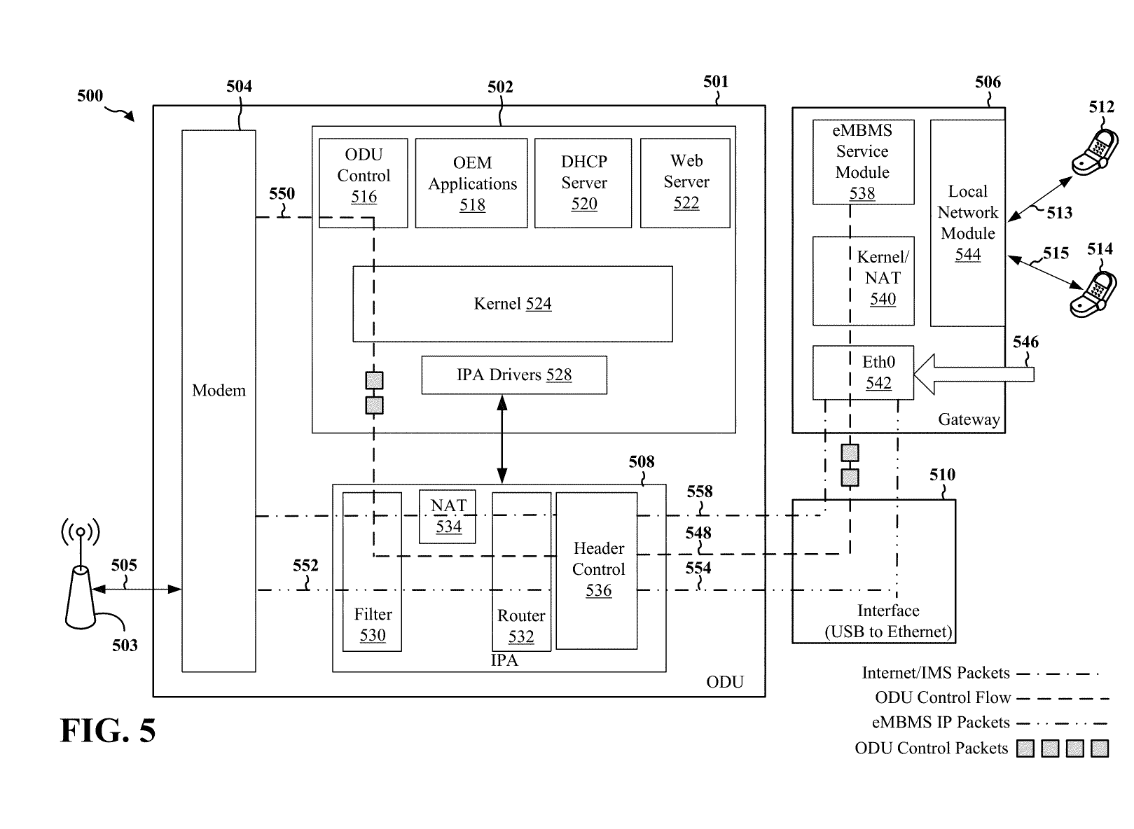

FIG. 5 is a diagram illustrating a network architecture 500 in accordance with various aspects of the disclosure. As shown in FIG. 5, network architecture 500 includes ODU 501, BS 503, gateway 506, interface 510, and one or more UEs (e.g., UEs 512, 514). For example, the ODU 501, BS 503, gateway 506, interface 510, and one or more UEs 512, 514 in FIG. 5 may correspond to ODU 404, BS 402, gateway 408, interface 406, and one or more UEs 412, 413 in FIG. 4, respectively. As shown in FIG. 5, the ODU 501 includes modem 504, central processing unit (CPU) 502, and Internet Protocol address (IPA) module 508. In an aspect, the modem 504 may include one or more antennas, a transceiver, and other suitable components for receiving wireless WAN signals (e.g., LTE signals) from the BS 503 through WAN link 505. The CPU 502 includes ODU control module 516, original equipment manufacturer (OEM) applications module 518, Dynamic Host Configuration Protocol (DHCP) server module 520, Web server module 522, Kernel module 524, and IPA drivers module 528. In an aspect, the Kernel module 524 may perform various functions, such as routing, network address translation, application layer gateway (ALG), firewall, port forwarding, and/or implementing a demilitarized zone (DMZ) (also referred to as a perimeter network) for added network security. For example, the DMZ may prevent external network devices to directly access a private LAN network while the hosts in the private LAN network are able access an external network. The IPA module 508 includes filter module 530, router module 532, network address translation (NAT) module 534, and header control module 536. The gateway 506 includes eMBMS service module 538 (also referred to as middleware module 538), Kernel/NAT module 540, Ethernet (Eth0) module 542, and local network module 544.

In an aspect, the ODU 501 is coupled to the gateway 506 through the interface 510. For example, the interface 510 may be a USB to Ethernet interface. As another example, the interface 510 may be a Peripheral Component Interconnect Express (PCIe) to Ethernet interface. In such example, the ODU 501 may send and receive communications to and from the gateway 506 using USB protocols. The gateway 506 may send and receive communications to and from the ODU 501 using Ethernet protocols. For example, the gateway 506 may send and/or receive ODU control packets along the ODU control flow path 548. For example, the ODU control packets may include one or more control messages indicating an eMBMS service requested by a UE (e.g., UE 512). In an aspect, the control messages may be eMBMS specific messages, such as a query message. For example, the query message may be configured to determine whether a network (e.g., LTE network) is eMBMS capable, to enable eMBMS service, and/or to activate/deactivate a channel (e.g., Temporary Mobile Group Identity (TMGI) activation/deactivation). As another example, the ODU control packets may be link status check messages as described infra.

In the aspect of FIG. 5, the ODU 501 may receive from BS 503 eMBMS data packets (also referred to as eMBMS IP packets) of an eMBMS service requested by a UE over WAN link 505. In an aspect, an eMBMS IP packet may be eMBMS data that is encapsulated using a standardized IP packet format. For example, the BS 503 may encapsulate eMBMS data as eMBMS IP packets and may use the File Delivery over Unidirectional Transport (FLUTE) protocol to deliver the eMBMS IP packets to a receiver within a FLUTE session established with the receiver. In one aspect, the gateway 506 may set up and control a FLUTE session with the BS 503 via the ODU 501. In such aspect, the gateway 506 may receive eMBMS IP packets from the BS 503 through the ODU 501.

The ODU 501 may route the eMBMS IP packets to the gateway 506 along paths 552 and 554 using the IPA 508. For example, the eMBMS IP packets may be IPv4 or IPv6 eMBMS packets. For example, the eMBMS IP packets received from BS 503 may be sent to the filter module 530, which may apply one or more filtering rules (e.g., a layer 3 filtering protocol) configured by the ODU 501. The eMBMS IP packets may then be sent to the header control module 536, which may add headers (or remove headers in some aspects) to the eMBMS IP packets. For example, the header control module 530 may add USB protocol headers to the eMBMS IP packets to enable transmission of the eMBMS IP packets using a USB protocol.

As further shown in FIG. 5, the ODU 501 may communicate Internet/IMS packets with the gateway 506 along Internet/IMS path 558. For example, the Internet/IMS packets may carry data for an IMS/Internet call established between ODU 501 and gateway 506. In an aspect, Internet/IMS PDN traffic over IPv4 or IPv6 is routed to the gateway 506 using the IPA 508.

As shown in FIG. 5, the gateway 506 includes a local network module 544 configured to enable communications with one or more UEs, such as UEs 512, 514. For example, the local network module 544 may be configured to communicate with the UEs 512, 514 using a WLAN protocol and/or a wired Ethernet protocol. Accordingly, in such example, the communication links 513, 515 may be a WLAN communication link or a wired Ethernet communication link. The UEs 512, 514 may be configured with one or more applications for processing various types of data traffic. For example, the UEs 512, 514 may include an eMBMS application for processing eMBMS data, and Internet application for processing Internet data, and/or an IMS application for processing IMS data. In an aspect, the gateway 506 may be configured to receive information 546 at the Ethernet module 542. For example, information 546 may be a private IPv4 address received via DHCP server module 520. As another example, the information 546 may be a network assigned IPv6 prefix.

In the aspect of FIG. 5, ODU 501 is configured to operate in router mode. In the router mode, a public IP address may be assigned to the ODU 501 and a private IP address may be assigned to the gateway 506. For example, the DHCP server module 520 may assign a private IP address (e.g., an IPv4 address) to the gateway 506. In an aspect, gateway 506 may acquire the private IPv4 address via the DHCP server module 520. In another aspect, the gateway 506 may acquire an IPv6 address assigned by the network via a stateless address autoconfiguration (SLAAC). For example, the IPv6 address may be globally unique and routable. The gateway 506 may be configured to operate behind a NAT firewall implemented by NAT module 534. In an aspect, the NAT module 534 may perform a network address translation function on Internet packets (e.g., Internet traffic) and/or IMS packets by modifying the destination address in the Internet packets and/or IMS packets from the public IP address to the private IP address. DHCP option #120 may be supported by the ODU 501 to send network assigned IPv4/v6 Proxy IMS call session control function (P-CSCF) addresses and a fully qualified domain name (FQDN) list to the gateway 506 to enable Session Initiation Protocol (SIP) calls. In the configuration of FIG. 5, PDN sharing is allowed, such that OEM applications running on the ODU 501 may use an Internet/IMS PDN call data pipe along with the gateway 506. As discussed supra, eMBMS IP packets over IPv4/v6 and/or Internet/IMS PDN traffic over IPv4/v6 may be routed to gateway 506 using IPA 508 (which may also be referred to as an IPA hardware offload engine).

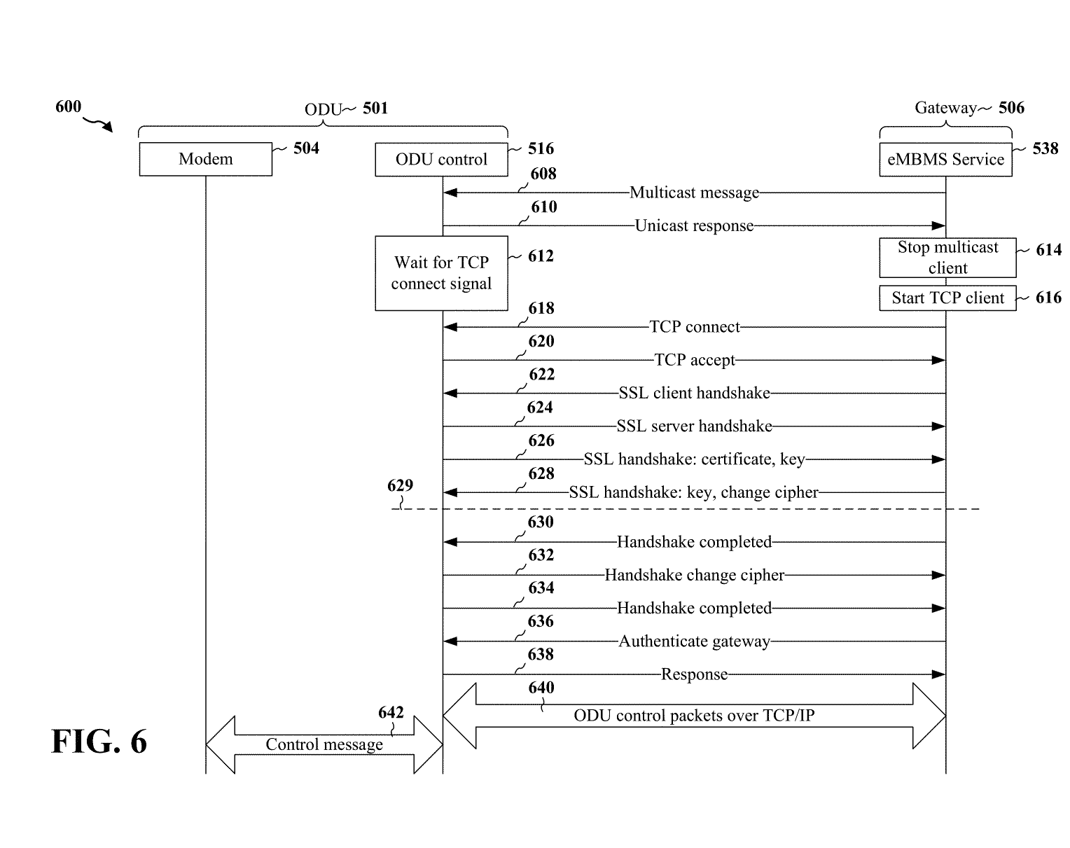

FIG. 6 is a diagram illustrating data flow 600 of the network architecture 500. In FIG. 6, the eMBMS service module 538 of gateway 506 sends multicast message 608 (also referred to as one or more multicast packets) to the ODU control module 516. In an aspect, the multicast message 608 may be sent to a predetermined UDP port. In an aspect, the multicast message 608 may be sent periodically based on a predetermined time interval. For example, the multicast message 608 may be sent once every 30 seconds. In an aspect, the gateway 506 may begin a timer when the multicast message 608 is sent. In such aspect, if a response (e.g., response message 610) to the multicast message 608 is not received, the eMBMS service module 538 may resend the multicast message 608. The eMBMS service module 538 may continue to resend the multicast message 608 until a response is received or until the timer expires. If the timer expires prior to receiving a response, the eMBMS service module 538 may determine that the ODU 501 is unavailable and may no longer resend the multicast message 608. In another aspect, if a response (e.g., response message 610) to the multicast message 608 is not received, the eMBMS service module 538 may resend the multicast message 608. In such aspect, the eMBMS service module 538 may maintain a count of the resent multicast messages 608. The eMBMS service module 538 may continue to resend the multicast message 608 until the count meets or exceeds a threshold. If the count meets or exceeds a threshold, the eMBMS service module 538 may determine that the ODU 501 is unavailable and may no longer resend the multicast message 608.

For example, the multicast message 608 may be a message that is generated using the IP version 6 (“IPv6”) communication protocol. For example, eMBMS service module 538 of the gateway 506 may generate the multicast message 608 by generating a UDP packet using the IPv6 local link address between the gateway 506 and ODU 501. For example, the content of the UDP packet may be a character string (e.g., a sequence of characters). The eMBMS service module 538 may send the UDP packet to a known UDP port. The ODU 501 may be configured to monitor the UDP port for UDP packets and may consider UDP packets received at the UDP port to be from the gateway 506.

In the aspect of FIG. 6, the IP address of the ODU 501 may not be known to the gateway 506. In such aspect, the multicast message 608 may enable the gateway 506 to discover the location (e.g., the IP address) and/or the presence of the ODU 501. For example, the ODU 501 may be configured to be in a waiting mode, during which the ODU listens for the multicast message 608 on the predetermined UDP port. Upon receiving the multicast message 608 at the ODU control module 516, the ODU 501 no longer remains in waiting mode and sends a response message 610 to the gateway 506. In an aspect, the response message may be a unicast message. The gateway 506 may determine the IP address of the ODU 501 by identifying the sender IP address included in the header of the unicast response message 610.

The ODU control module 516 waits at 612 for a TCP connect signal to initiate establishment of a secure connection. In an aspect, the TCP connection may be established on a predetermined TCP port. After the gateway 506 receives the unicast response 610, the gateway 506 stops the multicast client 614 and no longer sends the multicast message 608. The gateway 506 subsequently starts the TCP client 616. The gateway sends TCP connect message 618 to the ODU 501 and the ODU 501 sends a TCP accept message 620 in response. After the gateway 506 receives the TCP accept message 620, the gateway 506 initiates a Secure Sockets Layer (SSL) handshake with the ODU 501 by sending SSL client handshake message 622. The ODU 501 sends SSL server handshake message 624 in response, followed by SSL handshake message 626. In an aspect, the SSL handshake message 626 may contain a certificate and a key (e.g., a public key). The gateway 506 sends SSL handshake message 628 containing the key and a change cipher notification to indicate that the gateway 506 will start using the key for hashing and encrypting messages. Accordingly, as shown in FIG. 6, a secure connection (e.g., SSL connection) 629 is established between the gateway 506 and ODU 501. The gateway 506 sends a handshake completed message 630 to the ODU 501 over the secure connection. The ODU 501 sends a handshake change cipher message 632 over the secure connection in response, followed by a handshake completed message 634.

The gateway 506 sends a gateway authentication message 636 over the secure connection, which enables the ODU 501 to authenticate the gateway 506. After the ODU 501 authenticates the gateway 506, the ODU 501 sends a response 638 over the secure connection to the gateway 506. The gateway 506 and ODU 501 may then exchange ODU control packets 640 over the secure connection using TCP/IP protocols, and the ODU control 516 and modem 504 may exchange control messages 642.

In an aspect, the ODU control packets 640 may be sent by the gateway 506 to establish an MBMS session over the secure connection. The ODU 501 may decode the control packets and may initiate a modem service to establish the eMBMS session. For example, the modem service may be initiated by configuring the ODU control module 516 to send control message 642 to the modem 504. In an aspect, the MBMS session may be an eMBMS session.

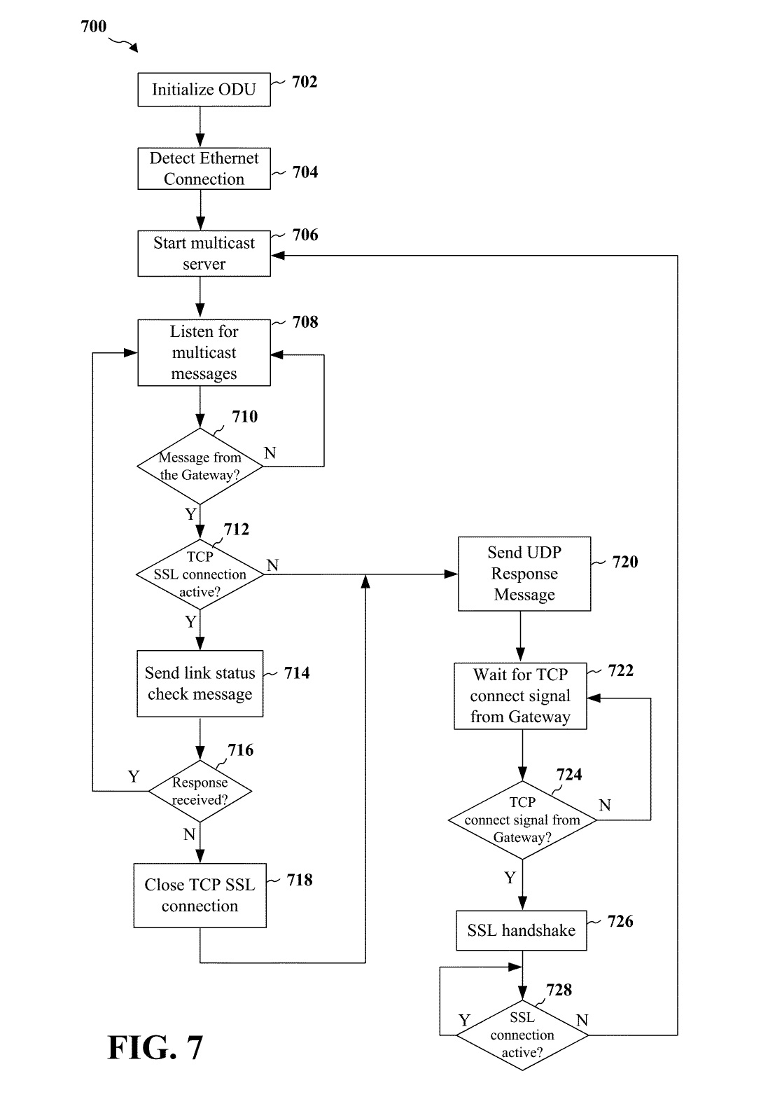

FIG. 7 is a flow chart 700 of a method for an ODU (e.g., ODU 501) in accordance with various aspects of the disclosure. At 702, the ODU is powered on and executes an initialization procedure. At 704, the ODU detects an Ethernet connection. For example, with reference to FIG. 5, the Ethernet connection may be the Ethernet connection between the interface 510 and the Ethernet (Eth0) module 542 of the gateway 506. At 706, the ODU starts a multicast server. At 708, the ODU listens for multicast messages. For example, the multicast message may be a UDP packet and the ODU may monitor a known UDP port for the UDP packet. At 710, the ODU determines whether a multicast message is received from the gateway. For example, the ODU may determine a UDP packet received at the known UDP port to be from the gateway 506. As another example, the ODU may identify the contents (e.g., a character string) of the multicast message as being from the gateway. If no multicast message from the gateway is received by the ODU, the ODU returns to 708 and continues to listen for multicast messages. Otherwise, if a multicast message is received from the gateway, then at 712, the ODU determines whether a TCP SSL connection between the ODU and gateway is active.

If a TCP SSL connection is active, then at 714, the ODU sends a link status check message to the gateway. At 716, the ODU determines whether a response to the link status check message is received. If a response is received, the ODU returns to 708 and continues to listen for multicast messages. Otherwise, if no response is received, at 718 the ODU closes the TCP SSL connection. Then, at 720 the ODU sends a UDP response message to the gateway to initiate establishment of a TCP connection.

If, at 712, the ODU determines that a TCP SSL connection (also referred to as an SSL connection) is not active, then at 720, the ODU sends a UDP response message to the gateway. At 722, the ODU waits for a TCP connect signal from the gateway. If the TCP connect signal is not from the gateway, the ODU returns to 722 and continues to wait for a TCP connect signal to initiate establishment of a secure connection. Otherwise, if the TCP connection request is from the gateway and the TCP connection is established, the ODU performs an SSL handshake at 726 to establish an SSL connection. For example, in order to establish an SSL connection, the gateway may send an SSL_connect message and the ODU may send an SSL_accept message. Thereafter, a certificate (e.g., X.509 certificate) and one or more keys may be exchanged between the gateway and the ODU. The ODU may determine whether the certificate is present and may validate the keys before establishing the SSL connection. In an aspect, the ODU may set a flag of a state machine to “true” when the SSL connection is successfully established. If the SSL connection fails, the ODU may clear the flag in the state machine by setting the flag to “false”. Accordingly, in an aspect, at 712, the ODU may determine whether the TCP SSL connection is active by determining the state of the flag in the state machine. For example, if the ODU determines that the flag is set to “true”, the ODU may determine that the SSL connection is active.

At 728, the ODU determines whether the SSL connection is active. In an aspect, the ODU may determine whether the SSL connection is active by determining a state of a flag in a state machine as described supra. For example, if the ODU determines that the flag is set to “true”, the ODU may determine that the SSL connection is active. If the SSL connection is active, the ODU returns to 728 and continues to determine whether the SSL connection is active. Otherwise, if, at 728, the ODU determines that the SSL connection is not active, the ODU returns to 706 and starts the multicast server.

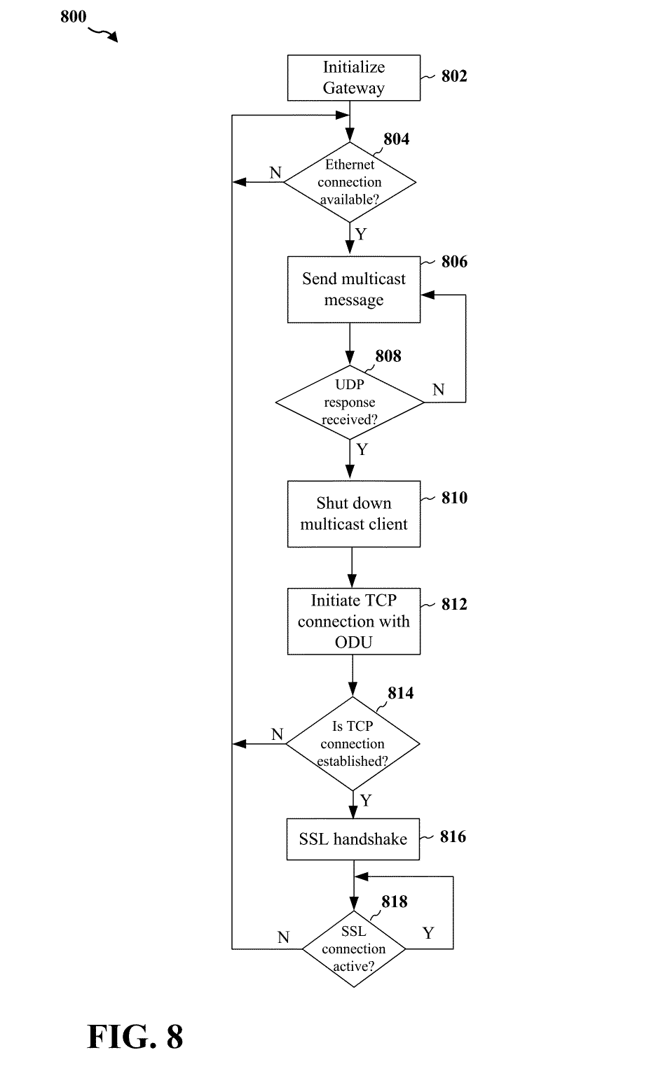

FIG. 8 is a flow chart 800 of a method for a gateway in accordance with various aspects of the disclosure. At 802, the gateway is powered on and goes through an initialization process. At 804, the gateway determines whether an Ethernet connection is available. If an Ethernet connection is not available, the gateway returns to 804 and continues to determine whether an Ethernet connection is available. Otherwise, if the gateway determines (804) that an Ethernet connection is available, then at 806, the gateway sends a multicast message to a predetermined UDP port. At 808, the gateway determines whether a UDP response is received. If the gateway determines (808) that a UDP response is not received, the gateway returns to 806 and continues to send one or more multicast messages. Otherwise, if the gateway determines (808) that a UDP response is received from the ODU, then at 810, the gateway shuts down the multicast client and no longer sends multicast messages. At 812, the gateway initiates a TCP connection with the ODU by sending a TCP connect message. At 814, the gateway determines whether the TCP connection has been established. In an aspect, the gateway may determine that the TCP connection is established based on a message received at a specified port from the ODU. For example, the message may indicate that the TCP connection is successful. If the TCP connection has not been established, the gateway returns to 804 and determines whether an Ethernet connection is available. Otherwise, if the TCP connection has been established, then at 816, the gateway performs an SSL handshake with the ODU to establish a secure connection. At 818, the gateway determines whether the SSL connection is active. For example, in order to establish an SSL connection, the gateway may send an SSL_connect message and the ODU may send an SSL_accept message. Thereafter, a certificate (e.g., X.509 certificate) and one or more keys may be exchanged between the gateway and the ODU. The ODU may determine whether the certificate is present and may validate the keys before establishing the SSL connection. Otherwise, if the keys cannot be validated, the ODU may return an error to the gateway. In an aspect, the gateway may set a flag of a state machine to “true” when the SSL connection is successfully established. If the SSL connection fails, the gateway may clear the flag in the state machine by setting the flag to “false”. Accordingly, the gateway may determine whether the SSL connection is active by determining the state of the flag in the state machine. For example, if the gateway determines that the flag is set to “true”, the gateway may determine that the SSL connection is active.

If the SSL connection is active, the gateway returns to 818 and determines whether the SSL connection is active. Otherwise, if the gateway determines (818) that the SSL connection is not active, the gateway returns to 804 and determines whether an Ethernet connection is available.

In one scenario, the end-to-end link from gateway 506 to ODU 501 established over a TCP connection (e.g., SSL connection) may fail due to one or more causes. In one example scenario, the end-to-end link may fail due to an error or malfunction of the eMBMS application operating in gateway 506. In such scenario, ODU 501 may unnecessarily consume power by continuing to send eMBMS data packets to gateway 506, where the eMBMS application operating in gateway 506 has failed and can no longer process the eMBMS packets from ODU 501. In another example scenario, the end-to-end link from ODU 501 to gateway 506 established over the TCP connection (e.g., SSL connection) may fail due to one or more causes. For example, the end-to-end link may fail due to an error or malfunction of the control plane of ODU 501. In such scenario, the TCP connection should be terminated and re-established after ODU 501 recovers from the error or malfunction. In the example scenarios discussed above, the TCP connection timeout configured to automatically terminate the TCP connection may be slow. As a result, there may be a large delay before the TCP connection can be re-established. Such delay may prevent reception of an eMBMS service before the TCP connection is re-established and, therefore, may degrade the user experience.

In an aspect, the ODU 501 and/or gateway 506 may determine whether the end-to-end link has failed through the use of link status check messages (also referred to as “heartbeat packets” in some aspects) communicated over the TCP connection (e.g., SSL connection) between the ODU 501 and the gateway 506. For example, the link status check message may be a message that includes one or more items of information, such as the time at which the message is sent. The receiver (e.g., gateway 506) of the link status check message may respond with a message that includes the one or more items of information included in the link status check message. In an aspect, if a response is not received by the sender (e.g., ODU 501) of the link status check message within a threshold period of time, the sender considers the end-to-end link to have failed. In such aspect, the sender of the link status check message may release all eMBMS/IMS/Internet resources and may proceed to terminate and re-establish the TCP connection. In an aspect, when ODU 501 detects a failure in the end-to-end link between ODU 501 and gateway 506, ODU 501 returns to an initialization state and listens for multicast messages on a predetermined UDP port. When ODU 501 receives a new multicast message from gateway 506, ODU 501 may respond to the multicast message with a unicast response message. The unicast response message may cause gateway 506 to initiate a new TCP connection establishment procedure. In an aspect, when gateway 506 detects a failure in the end-to-end link between ODU 501 and gateway 506, gateway 506 returns to an initialization state and attempts to discover ODU 501 by sending multicast messages to a predetermined UDP port.

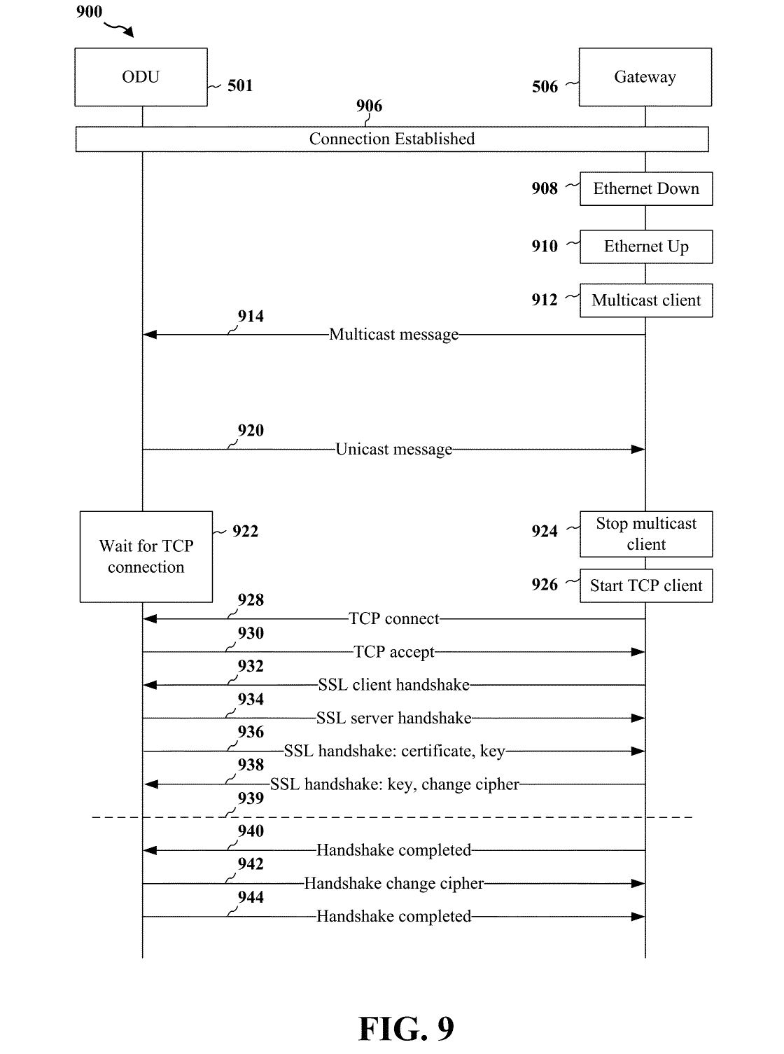

FIG. 9 is a diagram illustrating a message flow between an ODU and a gateway in accordance with various aspects of the disclosure. In FIG. 9, ODU 501 and gateway 506 establish a secure connection (e.g., an SSL connection) 906. As shown in FIG. 9, the gateway 506 determines that the Ethernet connection to the ODU 501 is not available (has failed) (908) and, consequently, that the secure connection 906 is no longer available. Subsequently, the gateway 506 determines that the Ethernet connection to the ODU 501 is available (910) and the gateway 506 initiates the multicast client (912). The gateway 506 sends a multicast message 914 to the ODU 501. The ODU 501 sends a unicast message 920 to the gateway 506 when a multicast message from the gateway is received. The ODU 501 then waits for a TCP connect signal to initiate establishment of a TCP connection (922). When the gateway 506 receives the unicast message 920, the gateway 506 stops the multicast client (924) and no longer sends multicast messages. The gateway 506 subsequently starts the TCP client (926). The gateway sends TCP connect message 928 to the ODU 501 and the ODU 501 sends a TCP accept message 930 in response. After the gateway 506 receives the TCP accept message 930, the gateway 506 initiates a Secure Sockets Layer (SSL) handshake with the ODU 501 by sending SSL client handshake message 932. The ODU 501 sends SSL server handshake message 934 in response, followed by SSL handshake message 936 containing a certificate that includes a key. The gateway 506 sends SSL handshake message 938 containing the key and a change cipher notification to indicate that the gateway 506 will start using the key for hashing and encrypting messages to the ODU. Accordingly, as shown in FIG. 9, a secure connection (e.g., SSL connection) 939 is established between the gateway 506 and ODU 501. The gateway 506 sends a handshake completed message 940 to the ODU 501 over the secure connection. The ODU 501 sends a handshake change cipher message 942 over the secure connection in response, followed by a handshake completed message 934.

In an aspect, the gateway 506 may send a gateway authentication message over the secure connection, which enables the ODU 501 to authenticate the gateway 506. After the ODU 501 authenticates the gateway 506, the ODU 501 may send a response over the secure connection to the gateway 506. The gateway 506 and ODU 501 may then exchange ODU control packets over the secure connection using TCP/IP protocols. In such aspect, the ODU control packets may be sent by the gateway 506 to establish an eMBMS session over the secure connection. The ODU 501 may decode the control packets and may send a request to the modem to establish an eMBMS session for the service of interest.

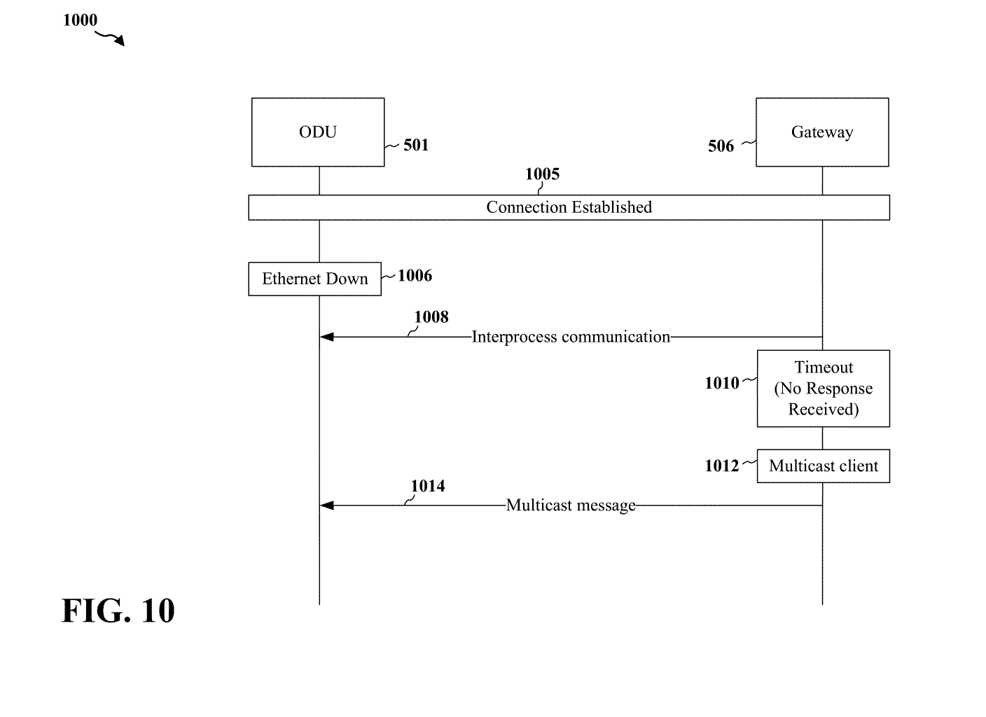

FIG. 10 is a diagram illustrating a message flow between an ODU and a gateway in accordance with various aspects of the disclosure. In FIG. 10, the ODU 501 and gateway 506 establish a secure connection (e.g., an SSL connection) 1005. As shown in FIG. 10, the ODU 501 determines that the Ethernet connection to the gateway 506 has failed (1006) and, consequently, the secure connection 1005 is no longer available. Subsequently, the ODU 501 receives an interprocess communication 1008. The gateway 506 determines that no response to the interprocess communication 1008 has been received within a threshold period of time after sending the interprocess communication 1008 and experiences a timeout 1010. The gateway 506 then initiates the multicast client 1012 to send multicast message 1014 to discover the ODU 501 and to reestablish a secure connection.

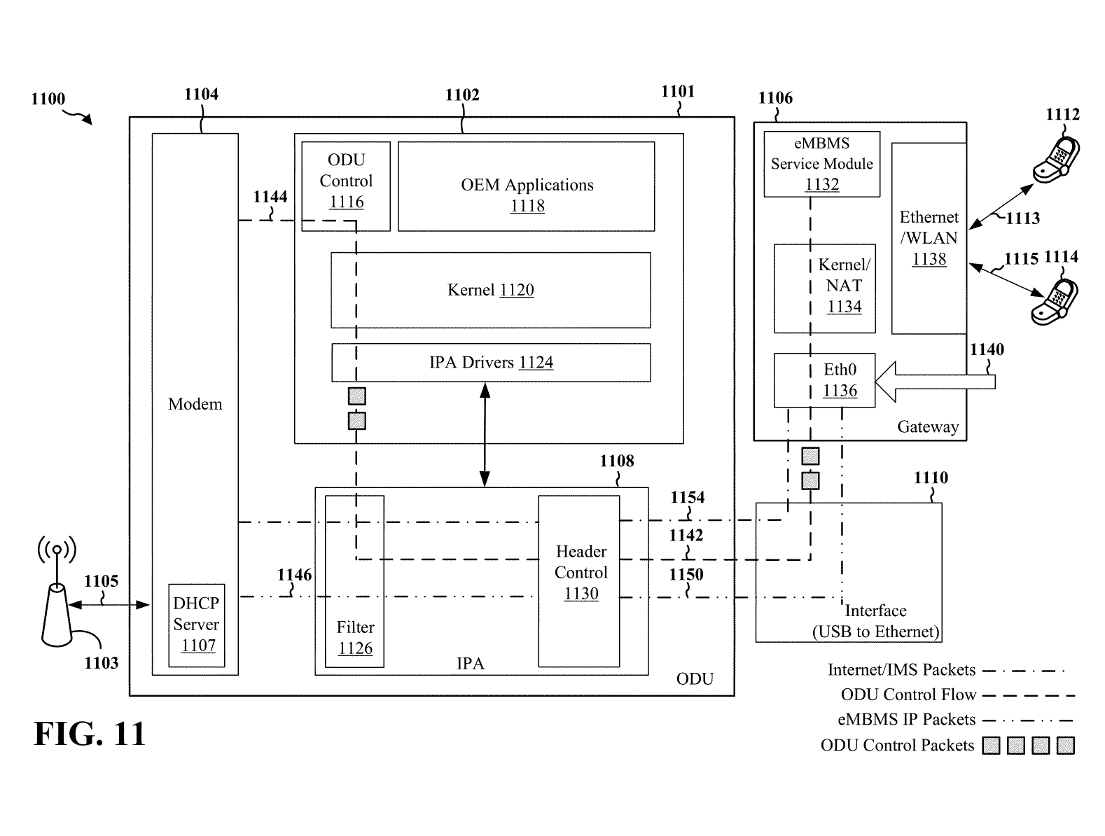

FIG. 11 is a diagram illustrating a network architecture 1100 in accordance with various aspects of the disclosure. As shown in FIG. 11, network architecture 1100 includes ODU 1101, BS 1103, gateway 1106, interface 1110, and one or more UEs (e.g., UEs 1112, 1114). For example, the ODU 1101, BS 1103, gateway 1106, interface 1110, and one or more UEs 1112, 1114 in FIG. 11 may correspond to ODU 404, BS 402, gateway 408, interface 406, and one or more UEs 412, 413 in FIG. 4, respectively. As shown in FIG. 11, the ODU 1101 includes modem 1104, CPU 1102, and IPA module 1108. The CPU 1102 includes ODU control module 1116, OEM applications module 1118, Kernel module 1120, and IPA drivers module 1124. In an aspect, the modem 1104 may include one or more antennas, a transceiver, and other suitable components for receiving wireless WAN signals (e.g., LTE signals) from the BS 1103 through WAN link 1105.

In an aspect, the Kernel module 1120 may perform various functions, such as ALG. The IPA module 1108 includes filter module 1126 and header control module 1130. The gateway 1106 includes eMBMS service module 1132 (also referred to as middleware module 1132), Kernel/NAT module 1134, Ethernet (Eth0) module 1136, and local network module 1138.

In an aspect, the ODU 1101 is coupled to the gateway 1106 through the interface 1110. For example, the interface 1110 may be a USB to Ethernet interface. In such example, the ODU 1101 may send and receive communications to and from the gateway 1106 using USB protocols. The gateway 1106 may send and receive communications to and from the ODU 1101 using Ethernet protocols. For example, the gateway 1106 may send and/or receive ODU control packets along the ODU control flow path 1142. The ODU packets may be received by the modem 1104 via ODU control flow path 1144. For example, the ODU control packets may include information indicating an eMBMS service requested by a UE (e.g., UE 1112). As another example, the ODU control packets may be link status check messages as described supra.

In the aspect of FIG. 11, the ODU 1101 may receive from BS 1103 eMBMS IP packets of an eMBMS service requested by a UE over WAN link 1105. The ODU 1101 may function as a bridge for delivering the eMBMS IP packets to the gateway 1106 along eMBMS IP paths 1146 and 1150 using the IPA 1108. For example, the eMBMS IP packets may be IPv4 or IPv6 eMBMS packets. For example, the eMBMS IP packets received from BS 1103 via eMBMS IP path 1146 may be sent to the filter module 1126, which may apply one or more filtering rules (e.g., a layer 3 filtering protocol) configured by the ODU 1101. The eMBMS IP packets may then be sent to the header control module 1130, which may add headers (or remove headers in some aspects) to the eMBMS IP packets. For example, the header control module 1130 may add USB protocol headers to the eMBMS IP packets to enable transmission of the eMBMS IP packets using a USB protocol.

As further shown in FIG. 11, the ODU 1101 may communicate Internet/IMS packets with the gateway 1106 along Internet/IMS path 1154. For example, the Internet/IMS packets may carry data for an IMS/Internet call established between ODU 1101 and gateway 1106. In an aspect, Internet/IMS PDN traffic over IPv4 or IPv6 are bridged to the gateway 1106 using the IPA 1108.

As shown in FIG. 11, the gateway 1106 includes a local network module 1138 configured to enable communications with one or more UEs, such as UEs 1112, 1114. For example, the local network module 1138 may be configured to communicate with the UEs 1112, 1114 using a WLAN protocol and/or a wired Ethernet protocol. Accordingly, in such example, the communication links 1113, 1115 may be a WLAN communication link or a wired Ethernet communication link. The UEs 1112, 1114 may be configured with one or more applications for processing various types of data traffic. For example, the UEs 1112, 1114 may include an eMBMS application for processing eMBMS data traffic, and Internet application for processing Internet data traffic, and/or an IMS application for processing IMS data traffic. In an aspect, the gateway 1106 may be configured to receive information 1140 at the Ethernet module 1136. For example, information 1140 may be a WWAN network assigned IPv4 address received via DHCP server module 1107 in modem 1104. As another example, the information 1140 may be a network assigned IPv6 prefix.

In the aspect of FIG. 11, ODU 1101 is configured to operate in a bridge mode. For example, the ODU 1101 may serve as a bridge to connect a WAN network (e.g., LTE network) to a local network served by the gateway 1106 without implementing a router and without network address translation. In the bridge mode, a public IP address (e.g., an IPv4 address) may be assigned to the ODU 1101. For example, the public IP address may be acquired by the ODU 1101 via the DHCP server 1107 in modem 1104. The gateway 1106 may acquire the public IP address from the DHCP server 1107 after the gateway 1106 discovers the ODU 1101 and establishes a TCP connection with the ODU 1101. In another aspect, gateway 1106 may further acquire an IPv6 prefix assigned by the network. It should be noted that since the configuration of FIG. 11 operates in bridge mode, the eMBMS IP packets received by the ODU 1101 may be forwarded to the gateway without network translation. As such, the gateway 1106 does not operate behind a NAT firewall. DHCP option #120 may be supported by the ODU 1101 to send network assigned IPv4/v6 P-CSCF addresses and an FQDN list to the gateway 1106 to enable SIP calls. PDN sharing is not allowed in the configuration of FIG. 11. As such OEM applications running on the CPU 1102 of the ODU 1101 may use other PDN types, but not the Internet/IMS PDN type. eMBMS packets over IPv4/v6 may be routed to gateway 1106 using IPA 1108 (also referred to as IPA hardware offload engine). Internet/IMS PDN traffic over IPv4/v6 may be bridged to gateway 1106 using IPA 1108.

In an aspect, a gateway (e.g., gateway 506 or gateway 1106) may configure the operation mode (e.g., router mode or bridge mode) of an ODU (e.g., ODU 501 or ODU 1101). For example, the gateway may send a message to the ODU that includes a configuration file instructing the ODU to operate in a router mode or in a bridge mode. The ODU may then reinitialize (also referred to as a reboot operation), read the configuration file, and begin operation in the mode (e.g., router mode or in a bridge mode) indicated in the configuration file.

Therefore, the disclosure includes a discovery mechanism of a network device (e.g., an ODU) by an end node (e.g., a gateway) and includes security for the control plane which is over IP. The disclosure further includes connection (e.g., end-to-end link between the network device and the end node) failure detection using link status check message between network device and the end node. The disclosure further includes a network device that can operate in a bridge or a router mode. eMBMS/IMS/Internet traffic from a WAN network is bridged or routed to the end node over an Ethernet link. The end node is agnostic to the mode (e.g., bridge mode or router mode) of the network device.

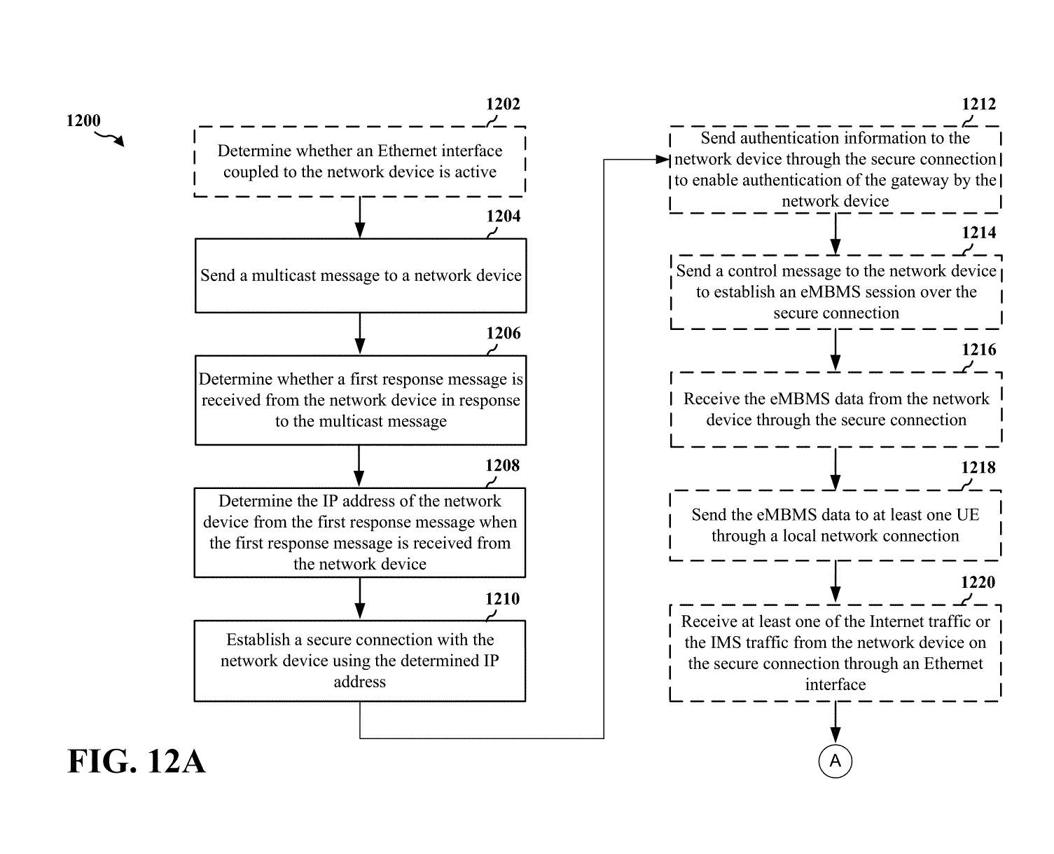

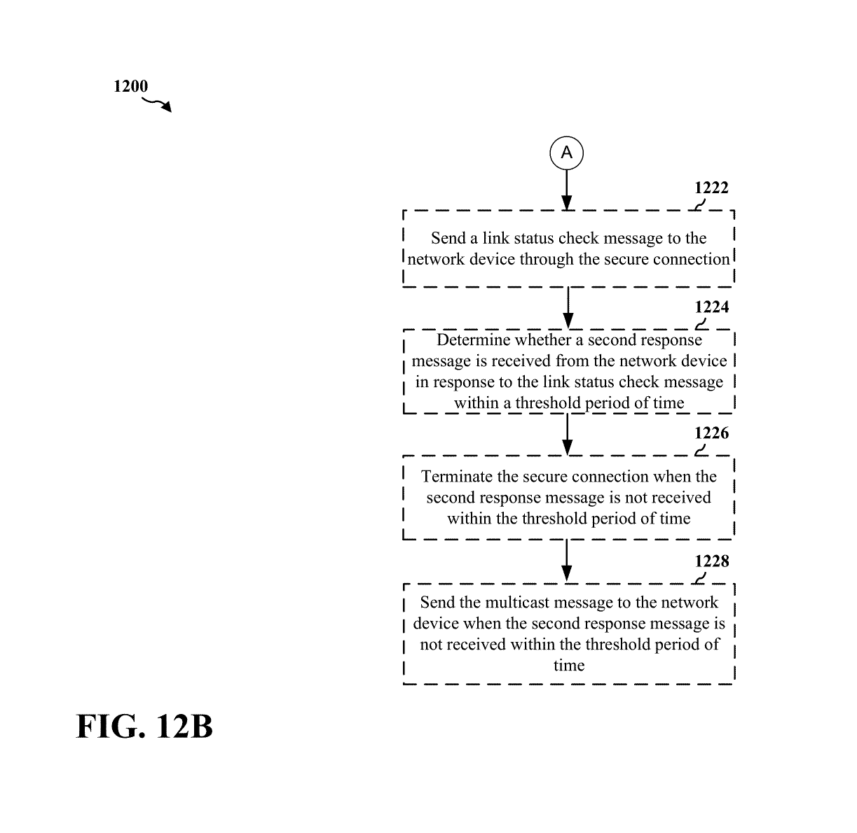

FIGS. 12A and 12B are a flow chart 1200 of a method of communication. The method may be performed by a gateway (e.g., gateway 506). It should be understood that the operations represented with dotted lines in FIGS. 12A and 12B represent operational operations. At 1202, the gateway determines whether an Ethernet interface coupled to a network device is active. In an aspect, the network device may be an ODU (e.g., ODU 501) configured to receive MBMS data, Internet traffic, and/or IMS traffic from a base station (e.g., base station 503). For example, with reference to FIG. 5, the gateway 506 may determine whether the Ethernet module 542 is initialized and capable of communicating with ODU 501.

At 1204, the gateway sends a multicast message to a network device (e.g., base station 503), where the IP address of the network device is unknown to the gateway. In an aspect, the gateway periodically sends the multicast message by sending the multicast message once every 30 seconds. In an aspect, the multicast message is periodically sent to the network device through the Ethernet interface when the Ethernet interface is determined to be active. For example, with reference to FIG. 6, the gateway 506 can send multicast message 608 to ODU 501.

At 1206, the gateway determines whether a first response message is received from the network device in response to the multicast message. At 1208, the gateway determines the IP address of the network device from the first response message when the first response message is received from the network device. In an aspect, the gateway determines the IP address by identifying the first response message and acquiring the IP address from the header of the response message. At 1210, the gateway establishes a secure connection with the network device using the determined IP address. In an aspect, the gateway establishes the secure connection by establishing a TCP connection with the network device and establishing an SSL connection using the TCP connection. For example, with reference to FIG. 6, the gateway 506 may establish the TCP connection by exchanging messages 618 and 620 with the ODU 501. The gateway 506 may establish the SSL connection by exchanging messages 622, 624, 626, 628, 630, 632, and 634 with the ODU 501.

At 1212, the gateway sends authentication information to the network device through the secure connection to enable authentication of the gateway by the network device. For example, with reference to FIG. 6, the gateway 506 may send gateway authentication message 636. At 1214, the gateway sends a control message to the network device to establish an eMBMS session over the secure connection. For example, with reference to FIG. 6, the gateway 506 may send ODU control packets 640 to the ODU 501.

At 1216, the gateway receives the eMBMS data from the network device through the secure connection. At 1218, the gateway sends the eMBMS data to at least one UE through a local network connection. In an aspect, the local network connection is a WLAN or a wired Ethernet connection. At 1220, the gateway receives Internet traffic and/or the IMS traffic from the network device, the Internet traffic and/or the IMS traffic being received on the secure connection through an Ethernet interface.

At 1222, the gateway sends a link status check message to the network device through the secure connection. At 1224, the gateway determines whether a second response message is received from the network device in response to the link status check message within a threshold period of time. At 1226, the gateway terminates the secure connection when the second response message is not received within the threshold period of time. At 1228, the gateway sends the multicast message to the network device when the second response message is not received within the threshold period of time. In an aspect, the link status check message and/or the multicast message may be sent periodically. For example, the link status check message may be periodically sent based on a time interval.

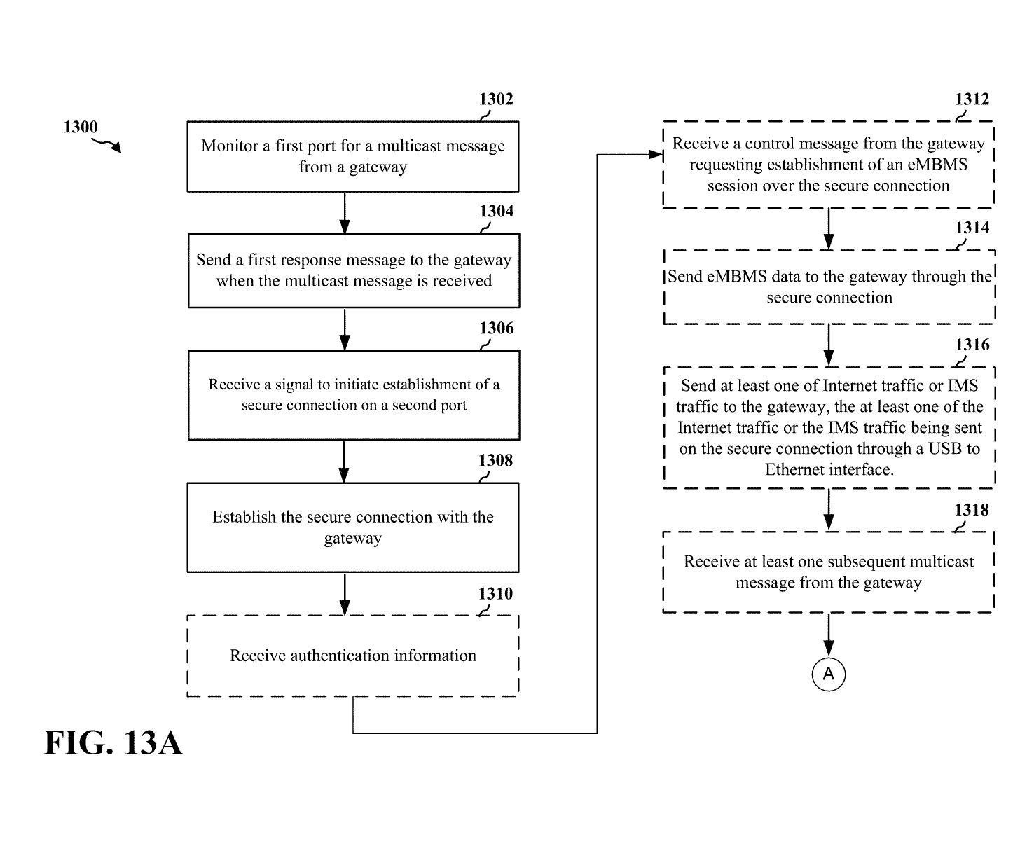

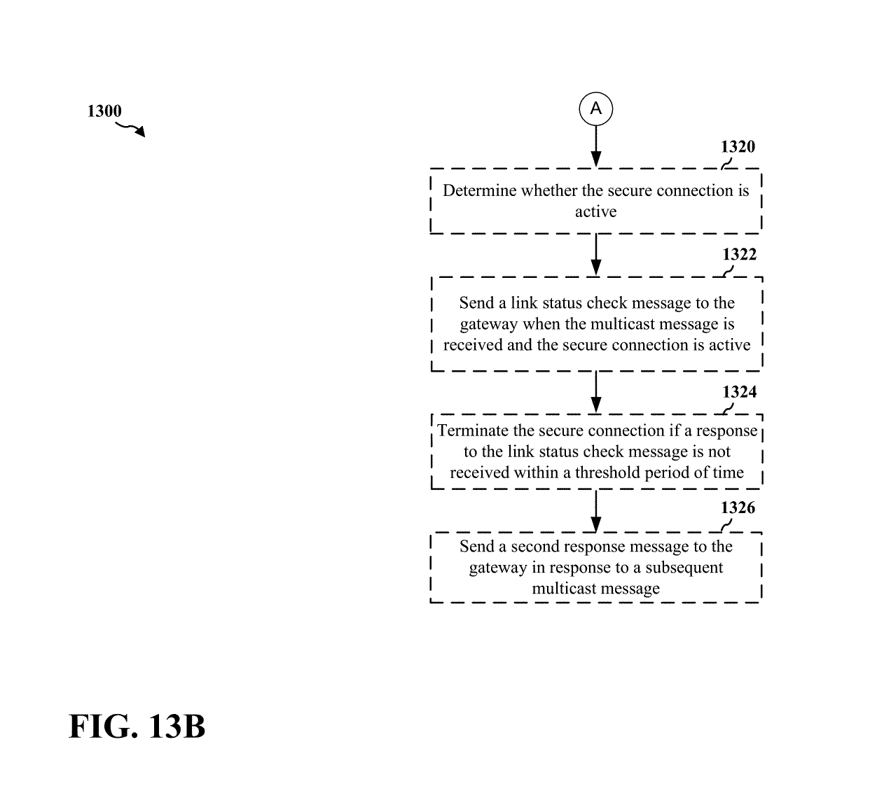

FIGS. 13A and 13B are a flow chart 1300 of a method of communication. The method may be performed by a network device (e.g., ODU 501). It should be understood that the operations represented with dotted lines in FIGS. 13A and 13B represent operational operations. At 1302, the ODU monitors a first port for multicast messages from a gateway. In an aspect, the monitoring is performed by identifying the first port and waiting for a multicast message to be received at the first port. At 1304, the ODU sends a response message to the gateway when the multicast message is received. At 1306, the ODU receives a signal configured to initiate establishment of a secure connection on a second port. In an aspect, the first port and the second port may be the same UDP port. At 1308, the ODU establishes the secure connection with the gateway. In an aspect, the ODU establishes the secure connection by establishing a TCP connection with the gateway and establishing an SSL connection using the TCP connection. At 1310, the ODU receives authentication information from the gateway configured to enable authentication of the gateway. At 1312, the ODU receives a control message from the gateway requesting establishment of an eMBMS session over the secure connection. At 1314, the ODU sends the eMBMS data to the gateway through the secure connection. At 1316, the ODU sends at least one of the Internet traffic or the IMS traffic to the gateway. In an aspect, the at least one of the Internet traffic or the IMS traffic is sent on the secure connection through a USB to Ethernet interface. At 1318, the ODU receives at least one subsequent multicast message from the gateway. At 1320, the ODU determines whether the secure connection is active. At 1322, the ODU sends a link status check message to the gateway when the multicast message is received and the secure connection is active. At 1324, the ODU terminates the secure connection if a response to the link status check message is not received within a threshold period of time. At 1326, the ODU sends a second response message to the gateway in response to the at least one subsequent multicast message.

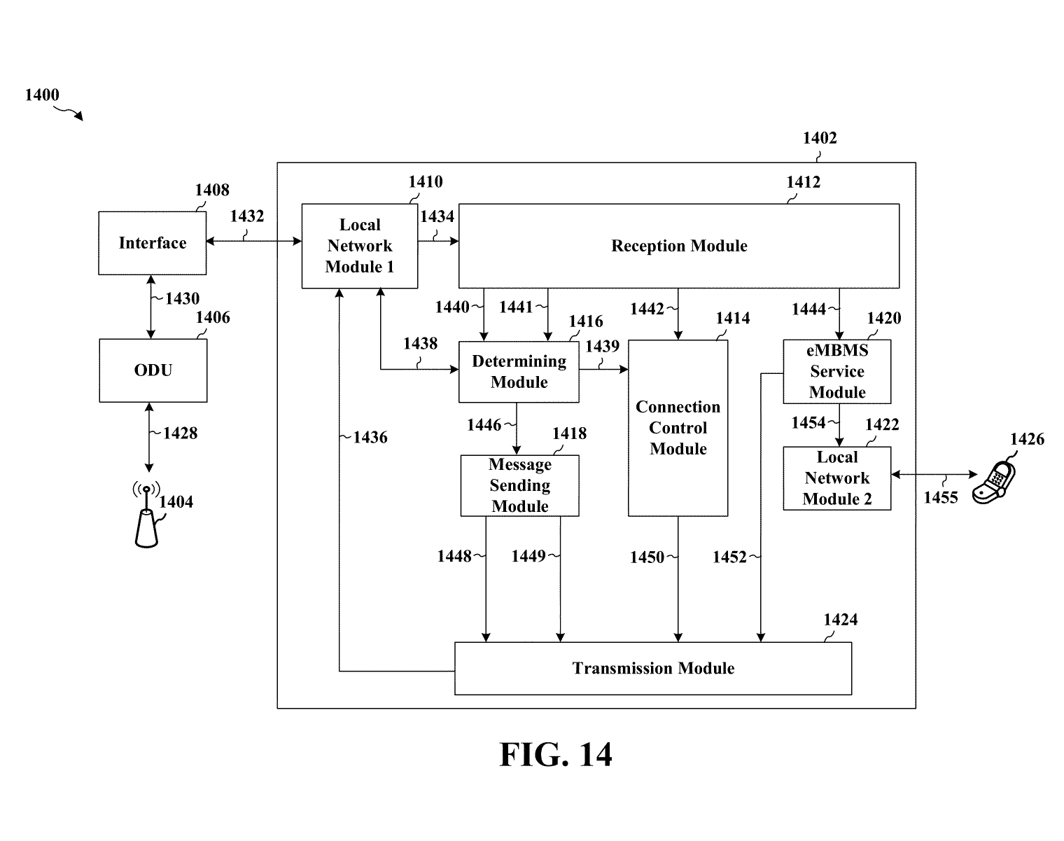

FIG. 14 is a conceptual data flow diagram 1400 illustrating the data flow between different modules/means/components in an exemplary apparatus 1402. The apparatus may be a gateway. The apparatus includes a local network module 1 1410 that communicates with ODU 1406 (also referred to as a network device) through interface 1408. In an aspect, the local network module 1 1410 may be an Ethernet module and the interface 1408 may be a USB to Ethernet interface. In such aspect, data path 1432 may be implemented as an Ethernet cable and data path 1430 may be implemented as a USB cable. The BS 1404 may be in communication with the ODU 1406 using WAN link 1428 (e.g., LTE).

The apparatus further includes a reception module 1412 that receives data 1434. In an aspect, the data 1434 may be Internet traffic, IMS traffic, or eMBMS data sent from the network device. Data 1434 may be received on the secure connection through the local network module 1 1410 (e.g., Ethernet module).

The apparatus further includes a connection control module 1414 that establishes a secure connection with the network device. The connection control module 1414 may receive messages 1442 (e.g., TCP accept and/or SSL handshake messages) and may send messages 1450 (e.g., TCP connect and/or SSL handshake messages) when establishing a TCP and/or SSL connection with the network device.

The apparatus further includes a determining module 1416 that determines whether an Ethernet module (also referred to as Ethernet interface) coupled to the network device is active. For example, the determining module 1416 may make the determination by checking the status of a flag (e.g., netif_carrier) in the local network module 1 1410. For example, the flag may be configured to indicate that the local network module 1 1410 is active when the flag is set to “true” and inactive when the flag is set to “false”. The determining module 1416 further determines whether a response message 1440 is received from the network device in response to the multicast message. The determining module 1416 further determines the IP address of the network device from the response message 1440 when the response message is received from the network device. The determining module 1416 further determines whether a second response message 1441 is received from the network device in response to the link status check message within a threshold period of time. The connection control module 1414 receives a signal 1439 that terminates the secure connection when the second response message is not received within the threshold period of time.

The apparatus further includes a message sending module 1418 that periodically sends multicast message 1448 to a network device. The message sending module 1418 receives the IP address 1446 from the determining module 1416. The message sending module 1418 periodically sends a link status check message 1449 to the network device through the secure connection. The message sending module 1418 sends the multicast message to the network device when the second response message is not received within the threshold period of time.

The apparatus further includes an eMBMS service module 1420 that sends a control message 1452 to the network device to establish an eMBMS session over the secure connection. The eMBMS service module 1420 receives eMBMS data 1444. The apparatus further includes a local network module 2 1422 that sends eMBMS data 1454 to at least one UE 1426 through a local network connection 1455. In an aspect, the local network connection 1455 is a WLAN or a wired Ethernet connection. The apparatus further includes a transmission module 1424 that sends authentication information over data path 1436 to the network device through the secure connection to enable authentication of the gateway by the network device.

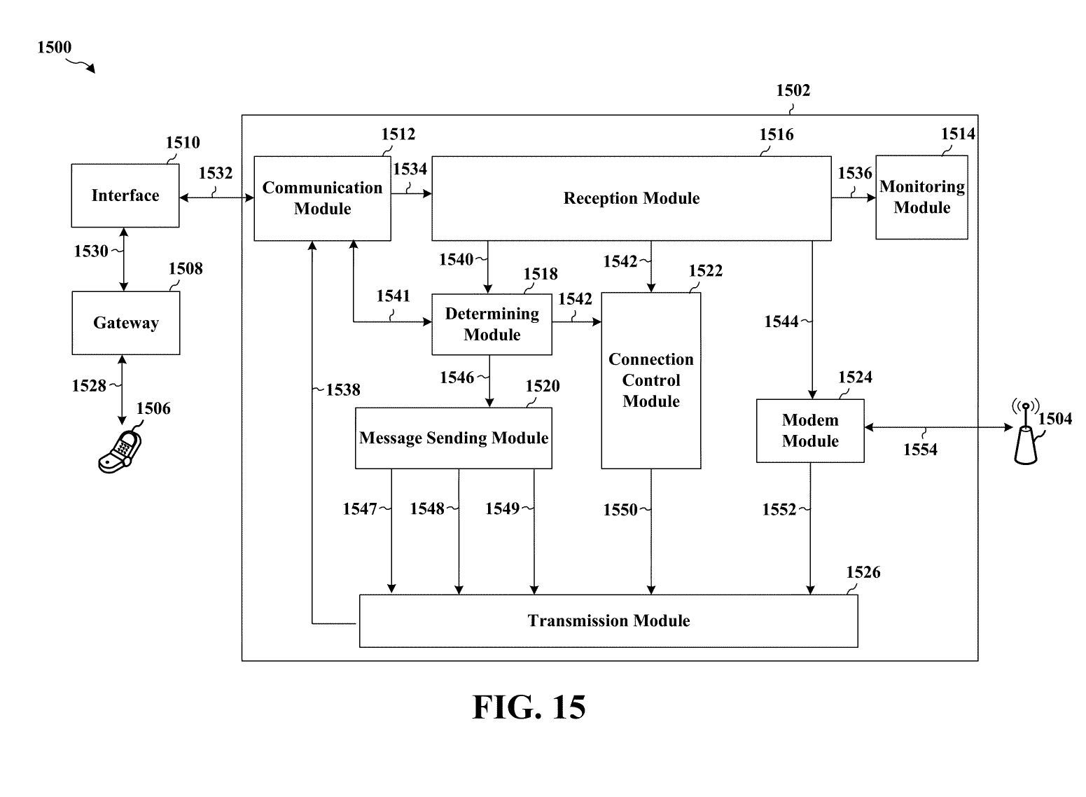

FIG. 15 is a conceptual data flow diagram 1500 illustrating the data flow between different modules/means/components in an exemplary apparatus 1502. The apparatus may be a network device (e.g., an ODU). The apparatus includes a communication module 1512 that communicates with a gateway (e.g., gateway 1508) through interface 1510. In an aspect, the communication module 1512 may be a USB module and the interface 1510 may be a USB to Ethernet interface. In such aspect, data path 1532 may be implemented as a USB cable and data path 1530 may be implemented as an Ethernet cable. The UE 1506 may be in communication with the gateway 1508 using a local network connection 1528 (e.g., WLAN or wired Ethernet).

The apparatus further includes a monitoring module 1514 that monitors a first port for multicast message 1536 from the gateway. The apparatus further includes a reception module 1516 that receives at least one subsequent multicast message via data path 1534 from the gateway, receives authentication information via data path 1534 from the gateway configured to enable authentication of the gateway, and/or receives control messages via data path 1534 from the gateway requesting establishment of an eMBMS session over the secure connection.

The apparatus further includes a determining module 1518 that determines whether the secure connection is active. The determining module 1518 may make the determination by inspecting activity on the communication module 1512 via data path 1541. The apparatus further includes a message sending module 1520 that sends a first response message 1547 to the gateway when the multicast message 1536 is received and/or sends a link status check message 1548 to the gateway when the multicast message 1536 is received and the secure connection is active. The message sending module 1520 may receive the determination (e.g., signal 1546) from the determining module 1518.

The apparatus further includes a connection control module 1522 that receives a signal to initiate establishment of a secure connection on a second port, establishes the secure connection with the gateway, and/or terminates the secure connection if a response to the link status check message is not received within a threshold period of time. For example, the connection control module 1522 may receive messages 1542 (e.g., TCP connect and/or SSL handshake messages) and may send messages 1550 (e.g., TCP accept and/or SSL handshake messages) when establishing a TCP and/or SSL connection with the gateway. The connection control module 1522 may receive the determination (e.g., signal 1542) from the determining module 1518.

The apparatus further includes a modem module 1524 that communicates with a BS 1504 using WAN protocols over WAN link 1554 (e.g., LTE). The modem 1524 may receive control information 1544 and may send IP packets 1552 (e.g., eMBMS data) to the gateway 1508. The apparatus further includes a transmission module 1526 that sends a second response message 1549 to the gateway 1508 in response to the at least one subsequent multicast message, sends the eMBMS data to the gateway 1508 through the secure connection, and/or sends Internet traffic and/or IMS traffic to the gateway 1508 on the secure connection through the interface 1510. The transmission module provides transmissions to the communication module 1512 through data path 1538.

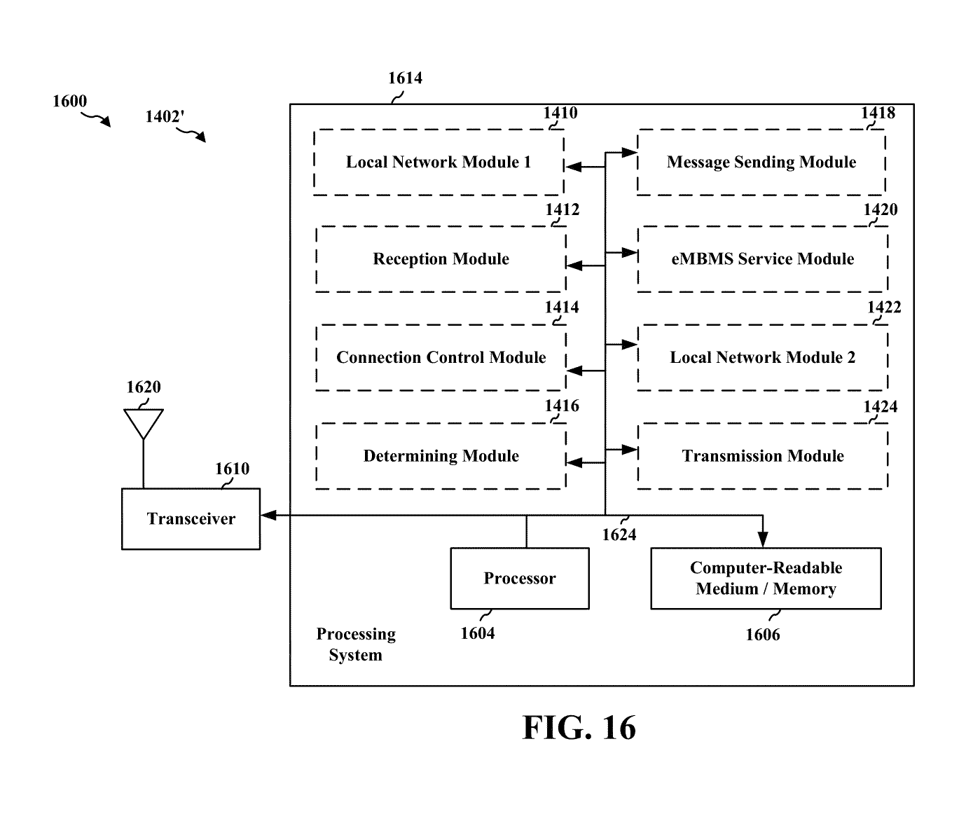

FIG. 16 is a diagram 1600 illustrating an example of a hardware implementation for an apparatus 1402′ employing a processing system 1614. The processing system 1614 may be implemented with a bus architecture, represented generally by the bus 1624. The bus 1624 may include any number of interconnecting buses and bridges depending on the specific application of the processing system 1614 and the overall design constraints. The bus 1624 links together various circuits including one or more processors and/or hardware modules, represented by the processor 1604, the modules 1410, 1412, 1414, 1416, 1414, 1420, 1422, and 1424, and the computer-readable medium/memory 1606. The bus 1624 may also link various other circuits such as timing sources, peripherals, voltage regulators, and power management circuits, which are well known in the art, and therefore, will not be described any further.

The processing system 1614 may be coupled to a transceiver 1610. The transceiver 1610 is coupled to one or more antennas 1620. The transceiver 1610 provides a means for communicating with various other apparatus over a transmission medium. The transceiver 1610 receives a signal from the one or more antennas 1620, extracts information from the received signal, and provides the extracted information to the processing system 1614, specifically the reception module 1412. In addition, the transceiver 1610 receives information from the processing system 1614, specifically the transmission module 1424, and based on the received information, generates a signal to be applied to the one or more antennas 1620. The processing system 1614 includes a processor 1604 coupled to a computer-readable medium/memory 1606. The processor 1604 is responsible for general processing, including the execution of software stored on the computer-readable medium/memory 1606. The software, when executed by the processor 1604, causes the processing system 1614 to perform the various functions described supra for any particular apparatus. The computer-readable medium/memory 1606 may also be used for storing data that is manipulated by the processor 1604 when executing software. The processing system further includes at least one of the modules 1410, 1412, 1414, 1416, 1418, 1420, 1422, and 1424. The modules may be software modules running in the processor 1604, resident/stored in the computer readable medium/memory 1606, one or more hardware modules coupled to the processor 1604, or some combination thereof.

In one configuration, the apparatus 1402/1402′ for wireless communication includes means for sending a multicast message to a network device configured to receive eMBMS data, Internet traffic, and/or IMS traffic from a base station, where the IP address of the network device is unknown, means for determining whether a first response message is received from the network device in response to the multicast message, means for determining the IP address of the network device from the first response message when the first response message is received from the network device, means for establishing a secure connection with the network device using the determined IP address, means for sending a link status check message to the network device through the secure connection, means for determining whether a second response message is received from the network device in response to the link status check message within a threshold period of time, means for terminating the secure connection when the second response message is not received within the threshold period of time, means for sending the multicast message to the network device when the second response message is not received within the threshold period of time, means for sending authentication information to the network device through the secure connection to enable authentication of the gateway by the network device, means for sending a control message to the network device to establish an eMBMS session over the secure connection, means for receiving the eMBMS data from the network device through the secure connection, means for sending the eMBMS data to at least one UE through a local network connection, means for receiving the Internet traffic and/or the IMS traffic from the network device on the secure connection through an Ethernet interface, and means for determining whether an Ethernet interface coupled to the network device is active. The aforementioned means may be one or more of the aforementioned modules of the apparatus 1402 and/or the processing system 1614 of the apparatus 1402′ configured to perform the functions recited by the aforementioned means.

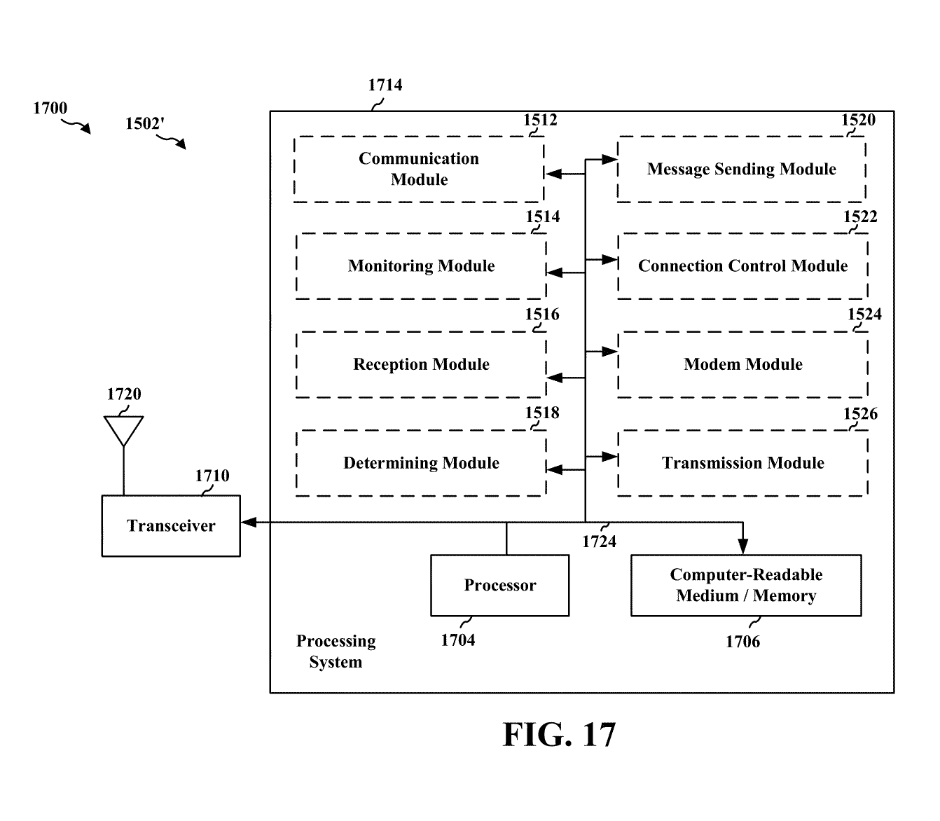

FIG. 17 is a diagram 1700 illustrating an example of a hardware implementation for an apparatus 1502′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware modules, represented by the processor 1704, the modules 1512, 1514, 1516, 1518, 1520, 1522, 1524, and 1526, and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception module 1516. In addition, the transceiver 1710 receives information from the processing system 1714, specifically the transmission module 1526, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system further includes at least one of the modules 1512, 1514, 1516, 1518, 1520, 1522, 1524, and 1526. The modules may be software modules running in the processor 1704, resident/stored in the computer readable medium/memory 1706, one or more hardware modules coupled to the processor 1704, or some combination thereof.

In one configuration, the apparatus 1502/1502′ for wireless communication includes means for monitoring a first port for the multicast message from a gateway, means for sending a response message to the gateway when the multicast message is received, means for receiving a signal to initiate establishment of a secure connection on a second port, means for establishing the secure connection with the gateway, means for receiving at least one subsequent multicast message from the gateway, means for determining whether the secure connection is active, means for sending a link status check message to the gateway when the multicast message is received and the secure connection is active, means for terminating the secure connection if a response to the link status check message is not received within a threshold period of time, means for sending a second response message to the gateway in response to the at least one subsequent multicast message, means for receiving authentication information from the gateway configured to enable authentication of the gateway, means for receiving a control message from the gateway requesting establishment of an eMBMS session over the secure connection, means for sending the eMBMS data to the gateway through the secure connection, means for sending at least one of the Internet traffic or the IMS traffic to the gateway, the at least one of the Internet traffic or the IMS traffic being sent on the secure connection through a USB to Ethernet interface. The aforementioned means may be one or more of the aforementioned modules of the apparatus 1502 and/or the processing system 1714 of the apparatus 1502′ configured to perform the functions recited by the aforementioned means.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of communication, comprising:
sending a multicast message to a network device, wherein an Internet Protocol (IP) address of the network device is unknown;
determining whether a first response message is received from the network device in response to the multicast message;
determining the IP address of the network device from the first response message when the first response message is received from the network device; and
establishing a secure connection with the network device using the determined IP address.

2. The method of claim 1, further comprising:
sending a link status check message to the network device through the secure connection;
determining whether a second response message is received from the network device in response to the link status check message within a threshold period of time;
terminating the secure connection when the second response message is not received within the threshold period of time; and
sending the multicast message to the network device when the second response message is not received within the threshold period of time.

3. The method of claim 1, wherein establishing the secure connection comprises:
establishing a Transmission Control Protocol (TCP) connection with the network device; and
establishing a Secure Sockets Layer (SSL) connection using the TCP connection.

4. The method of claim 1, further comprising sending authentication information to the network device through the secure connection to enable authentication by the network device.

5. The method of claim 1, further comprising:
sending a control message to the network device to establish an MBMS session over the secure connection; and
receiving MBMS data from the network device through the secure connection.

6. The method of claim 5, further comprising sending the MBMS data to at least one UE through a local network connection.

7. The method of claim 6, wherein the local network connection comprises a wireless local area network (WLAN) or a wired Ethernet connection.

8. The method of claim 1, further comprising determining whether an Ethernet interface coupled to the network device is active, wherein the multicast message is periodically sent to the network device through the Ethernet interface when the Ethernet interface is determined to be active.

9. The method of claim 1, wherein the network device is configured to receive at least one of Multimedia Broadcast Multicast Service (MBMS) data, Internet traffic, or Internet Protocol Multimedia Subsystem (IMS) traffic from a base station.

10. The method of claim 1, wherein sending the multicast message to the network device comprises periodically sending the multicast message to the network device based on a time interval.

11. A method of communication for a network device, comprising:
monitoring a first port for a multicast message from a gateway;
sending a first response message to the gateway when the multicast message is received;
receiving a signal to initiate establishment of a secure connection on a second port; and
establishing the secure connection with the gateway.

12. The method of claim 11, further comprising:
receiving a subsequent multicast message from the gateway;
determining whether the secure connection is active;
sending a link status check message to the gateway when the multicast message is received and the secure connection is active;
terminating the secure connection if a response to the link status check message is not received within a threshold period of time; and
sending a second response message to the gateway in response to the subsequent multicast message.

13. The method of claim 11, wherein establishing the secure connection comprises:
establishing a Transmission Control Protocol (TCP) connection with the gateway; and
establishing a Secure Sockets Layer (SSL) connection using the TCP connection.

14. The method of claim 11, further comprising receiving authentication information from the gateway configured to enable authentication of the gateway.

15. The method of claim 11, further comprising:
receiving a control message from the gateway requesting establishment of an MBMS session over the secure connection; and
sending MBMS data to the gateway through the secure connection.

16. An apparatus for wireless communication, comprising:
a memory; and
at least one processor coupled to the memory and configured to:
send a multicast message to a network device, wherein an Internet Protocol (IP) address of the network device is unknown;
determine whether a first response message is received from the network device in response to the multicast message;
determine the IP address of the network device from the first response message when the first response message is received from the network device; and
establish a secure connection with the network device using the determined IP address.

17. The apparatus of claim 16, wherein the at least one processor is further configured to:
send a link status check message to the network device through the secure connection;
determine whether a second response message is received from the network device in response to the link status check message within a threshold period of time;
terminate the secure connection when the second response message is not received within the threshold period of time; and
send the multicast message to the network device when the second response message is not received within the threshold period of time.

18. The apparatus of claim 16, wherein to establish the secure connection, the at least one processor is further configured to:
establish a Transmission Control Protocol (TCP) connection with the network device; and
establish a Secure Sockets Layer (SSL) connection using the TCP connection.

19. The apparatus of claim 16, wherein the at least one processor is further configured to send authentication information to the network device through the secure connection to enable authentication by the network device.

20. The apparatus of claim 16, wherein the at least one processor is further configured to:
send a control message to the network device to establish an MBMS session over the secure connection; and
receive MBMS data from the network device through the secure connection.

21. The apparatus of claim 20, wherein the at least one processor is further configured to send the MBMS data to at least one UE through a local network connection.

22. The apparatus of claim 21, wherein the local network connection comprises a wireless local area network (WLAN) or a wired Ethernet connection.

23. The apparatus of claim 16, wherein the network device is configured to receive at least one of Multimedia Broadcast Multicast Service (MBMS) data, Internet traffic, or Internet Protocol Multimedia Subsystem (IMS) traffic from a base station.

24. The apparatus of claim 16, wherein the at least one processor is configured to send the multicast message by periodically sending the multicast message to the network device based on a time interval.

25. An apparatus for wireless communication, comprising:
a memory; and
at least one processor coupled to the memory and configured to:
monitor a first port for a multicast message from a gateway;
send a response message to the gateway when the multicast message is received;
receive a signal to initiate establishment of a secure connection on a second port; and
establish the secure connection with the gateway.

26. The apparatus of claim 25, wherein the at least one processor is further configured to:
receive a subsequent multicast message from the gateway;
determine whether the secure connection is active;
send a link status check message to the gateway when the multicast message is received and the secure connection is active;
terminate the secure connection if a response to the link status check message is not received within a threshold period of time; and
send a second response message to the gateway in response to the subsequent multicast message.

27. The apparatus of claim 25, wherein to establish the secure connection, the at least one processor is further configured to:
establish a Transmission Control Protocol (TCP) connection with the gateway; and
establish a Secure Sockets Layer (SSL) connection using the TCP connection.

28. The apparatus of claim 25, wherein the at least one processor is further configured to:
receive a control message from the gateway requesting establishment of an MBMS session over the secure connection; and
send MBMS data to the gateway through the secure connection.

29. The apparatus of claim 25, wherein the at least one processor is configured to receive at least one of Multimedia Broadcast Multicast Service (MBMS) data, Internet traffic, or Internet Protocol Multimedia Subsystem (IMS) traffic from a base station.

30. The apparatus of claim 25, wherein the at least one processor is further configured to receive authentication information configured to enable authentication of the gateway.
